(19) United States
(12) Patent Application Publication
(10) Pub. No.: US 2009/0035682 A1
(43) Pub. Date: Feb. 5, 2009

(54) TONER AND PROCESS FOR PRODUCING THE SAME

(75) Inventors: Michihiro Shima, Osaka (JP); Hidekazu Arase, Hyogo (JP); Yasuhito Yuasa, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 12/162,063

(22) PCT Filed: Dec. 5, 2006
(86) PCT No.: PCT/JP2006/324244

§ 371 Date: Jul. 24, 2008

(30) Foreign Application Priority Data
Jan. 24, 2006 (JP) 2006-014866

(51) Int. Cl. G03G 9/08; G03G 5/02

(52) U.S. Cl. 430/108.4; 430/111.4; 430/108.8; 430/137.14

(57) ABSTRACT

A toner of the present invention includes a first wax and a second wax. The endothermic peak temperature of the first wax by the DSC method is 50° C. to 90° C. The endothermic peak temperature of the second wax is 5° C. to 50° C. higher than that of the first wax. Jmw1/Jw1 is 0.5 or less and Jmw2/Jw2 is 0.5 to 1.2, where Jw1 represents the endotherm of the first wax, Jw2 represents the endotherm of the second wax, Jmw1 represents the melting endotherm of the first wax by the MDSC method, and Jmw2 represents the melting endotherm of the second wax. The first wax and the second wax are mixed into a dispersion beforehand, the dispersion is then mixed with a resin particle dispersion and a colorant particle dispersion, and the particles are aggregated to form core particles. Thus, a toner having a small particle size and a sharp particle size distribution can be produced without requiring a classification process.

### TECHNICAL FIELD

The present invention relates to a toner used, e.g., in copiers, laser printers, plain paper facsimiles, color PPCs, color laser printers, color facsimiles or multifunctional devices, and a method for producing the toner.

### BACKGROUND ART

In recent years, the use of image forming apparatuses such as a printer has been shifting increasingly from office to personal purposes, and there is a growing demand for technologies that can achieve, e.g., a small size, a high speed, high image quality, or high reliability for those apparatuses. Under such circumstances, a tandem color process and oilless fixing are required along with better maintainability and less ozone emission. The tandem color process enables high-speed output of color images. The oilless fixing can provide both offset resistance and clear color images with high glossiness and high transmittance, even if no fixing oil is used to prevent offset during fixing. These functions should be performed at the same time, and therefore improvements in the toner characteristics as well as the processes are important factors.

In a fixing process for color images of a color printer, it is necessary for each color of toner to be melted and mixed sufficiently to increase the transmittance. In this case, a melt failure of the toner may cause light scattering on the surface or the inside of the toner image, and thus affects the original color of the toner pigment. Moreover, light does not reach the lower layer of the superimposed images, resulting in poor color reproduction. Therefore, the toner should have a property of complete melting and transmittance high enough not to reduce the original color. In particular, the need for light transmittance for an OHP sheet is increasing with an increase in opportunities to give a color presentation.

During the formation of color images, the toner may adhere to the surface of a fixing roller and cause offset. Therefore, a large amount of oil or the like should be applied to the fixing roller, which makes the handling or configuration of equipment more complicated. Thus, oilless fixing (no oil is used for fixing) is required to provide compact, maintenance-free, and low-cost equipment. To achieve the oilless fixing, e.g., a toner having a configuration in which a release agent (wax etc.) is added in a binder resin with a sharp melting property is being put to practical use.

However, such a toner is very prone to a transfer failure or toner image disturbance during transfer because of its strong cohesiveness. Therefore, it is difficult to ensure the compatibility between transfer and fixing. When the toner is used as a two-component developer, so-called spent, in which a low-melting component of the toner adheres to the surface of a carrier, is likely to occur due to heat generated by mechanical collision or friction between the particles of the toner and the carrier or between the particles and the developing unit. This decreases the charging ability of the carrier for the toner and reduces the life of the two-component developer.

A variety of configurations for a toner have been proposed. As is well known, a toner for electrostatic charge development used in electrophotography generally includes a resin component as a binder resin, a coloring component of a pigment or dye, and any other additives such as a plasticizer, a charge control agent, and if necessary, a release agent. As the resin component, a natural or synthetic resin may be used alone or in combination appropriately.

After the above additives are pre-mixed in a predetermined ratio, the components are heated, kneaded, and thermally melted. Then, the mixture is pulverized by an air stream collision board system and classified as fine powder, thus producing a toner base. The toner base also may be produced by chemical polymerization. Subsequently, an additive such as hydrophobic silica is added to the toner base, so that the toner is completed. A single-component developer includes only the toner, while a two-component developer is obtained by mixing the toner and a carrier composed of magnetic particles.

Even with pulverization and classification of the conventional kneading and pulverizing processes, the actual particle size can be reduced to only about 8 μm in view of the economic and performance conditions. At present, various methods are considered to produce a toner having a smaller particle size. Moreover, a method for achieving the oilless fixing by adding a release agent (wax etc.) in a resin with a low softening property during melting and kneading also is considered. However, there is a limit to the amount of wax that can be added, and increasing the amount of wax may cause problems such as low flowability of the toner, transfer voids, and filming of the toner on a photoconductive member. On the other hand, a method for producing a toner by emulsion polymerization includes the following steps: forming core particles in a dispersion in which resin particles and colorant particles such as a pigment are dispersed; and heating and fusing the core particles.

Patent Document 1 discloses the following: a first step of preparing an aggregated particle dispersion by heating a dispersion in which at least resin particles are dispersed at a temperature of not more than a glass transition point of the resin particles to form core particles; a second step of forming adhesive particles by adding a fine particle dispersion in which fine particles are dispersed to the aggregated particle dispersion and mixing them together so that the fine particles adhere to the aggregated particles; and heating and fusing the adhesive particles. With this configuration, it is described that various properties such as a developing property, transfer property, fixability, and cleaning property are improved, and these properties are maintained and exhibited stably, so that highly reliable effects can be obtained.

Patent Document 2 discloses a method for producing a toner for electrostatic charge image development that includes the following: mixing a resin particle dispersion in which at least resin particles are dispersed, a colorant particle dispersion in which at least colorant particles are dispersed, and a release agent particle dispersion in which at least release agent particles are dispersed; aggregating these particles; and heating and fusing the aggregated particles. In this method, the volume average particle size of the release agent particles is smaller than 0.5 μm, and the amount of particles with a particle size of 1.0 μm or more is 5% or less. It is described that since the dispersion diameter of the release agent is smaller than the wavelength region of visible light, the liberation of the release agent can be prevented during the aggregation and fusion processes, and thus uniform high-quality toner particles can be produced stably. Moreover, since the dispersion diameter of the release agent is smaller than the wavelength region of visible light, the color development of the toner is improved, and the OHP transmittance also is increased. Further, the amount of the release agent incorporated into the toner can be increased, resulting in a toner with an excellent fixing property.

Patent Document 3 discloses a process of preparing a liquid mixture by mixing at least a resin particle dispersion in which resin particles are dispersed in a dispersing agent having a polarity and a colorant particle dispersion in which colorant particles are dispersed in a dispersing agent having a polarity. The dispersing agents included in the liquid mixture have the same polarity, so that a toner for electrostatic charge image development with high reliability and excellent charging property and color development property can be produced in a simple and easy manner. Moreover, it is described that various properties such as a color development property, charging property, developing property, transfer property, and fixability, particularly the charging property and the color development property are improved, so that highly reliable effects can be obtained.

Patent Document 4 discloses a release agent including at least one type of ester composed of at least one selected from a higher alcohol having a carbon number of 12 to 30 and a higher fatty acid having a carbon number of 12 to 30, and resin particles including at least two types of resin particles with different molecular weights. As the release agent, waxes such as low molecular-weight polyolefins, fatty acid amides, vegetable waxes, a paraffin wax, a microcrystalline wax, and a Fischer-Tropsch wax are disclosed. It is described that the amount of the release agent liberated is small, and consequently the amount of the release agent present on the toner surface is small. This can prevent background fog or the like caused by a charge failure due to the adhesion of the liberated release agent to the surface of the individual toner particles. Therefore, it is possible to suppress effectively a reduction in color development property and transparency due to light scattering of the release agent. In particular, even if the amount of the release agent incorporated into the toner is increased for use in color applications, high-quality copy images can be formed stably.

Patent Document 5 discloses a toner for electrophotography that includes at least a binder resin, a colorant, and a release agent in an amount of 10 to 25 mass % of the toner particles. The shape factor SF1 is 140 or less, and the average domain diameter of the release agent is 0.5 to 2.3 μm. It is described that the use of this toner can provide images having high glossiness, excellent storage stability, and high transparency even for OHP etc. while maintaining high productivity.

Patent Document 6 discloses a toner including at least a binder resin, a colorant, and two or more types of release agents. The weight-average molecular weight Mw of the binder resin is 6000 to 45000. Among the two or more types of release agents, the melting point α of the release agent having a lowest melting point is 90° C. to 115° C., and the melting point of at least one of the other release agents having a higher melting point is 1.3α° C. to 2.1α° C. It is described that even if glossy paper is used, images with high glossiness equivalent to that of the glossy paper can be provided in a high-speed process, and the storage stability of a document can be improved. Patent Document 7 discloses a toner including at least a binder resin, a colorant, and a release agent. It is described that the toner is produced by salting-out/fusion of the resin particles, in each of which the release agent is incorporated into the binder resin, and the colorant.

However, when the dispersibility of the release agent added is lowered, the toner images melted during fixing tend to have a dull color. This also decreases the pigment dispersibility, and thus the color development property of the toner becomes insufficient. In the subsequent process, when resin particles further adhere to the surfaces of aggregated particles, the adhesion of the resin particles is unstable due to the low dispersibility of the release agent or the like. Moreover, the release agent that once was aggregated with the resin is liberated into an aqueous medium. A use of releasing agent. The polarity or the thermal properties such as a melting point of the wax to be used may have a considerable effect on the mixing and aggregation of the particles. Further, a specified wax is added in a large amount to achieve the oilless fixing (no oil is used for fixing).

When particles are formed by an aggregation reaction in the medium containing at least a predetermined amount of wax, the particle size increases with the heat treatment time. Therefore, it is difficult to produce small particles having a narrow particle size distribution.

The use of a release agent may achieve the oilless fixing, reduce fog during development, and improve the transfer efficiency. However, uniform mixing and aggregation with the resin particles and the pigment particles in the aqueous medium can be prevented during the manufacture. Consequently, the release agent is not aggregated but suspended in the aqueous medium, and the aggregated and fused particles are likely to be coarser due to the effect of the release agent.

Patent Document 1: JP 10 (1998)-026842 A

Patent Document 2: JP 11 (1999)-002922 A

Patent Document 3: JP 10 (1998)-198070 A

Patent Document 4: JP 10 (1998)-301332 A

Patent Document 5: JP 2003-215842 A

Patent Document 6: JP 2004-198862 A

Patent Document 7: JP 2001-272819 A

### DISCLOSURE OF INVENTION

It is an object of the present invention to provide a toner that can have a small particle size and a sharp particle size distribution without requiring a classification process, and that can achieve low-temperature fixability, high-temperature offset resistance, separability of paper from a fixing roller or the like, and storage stability at high temperatures by using a release agent such as wax in the toner in oilless fixing (no oil is applied to the fixing roller) and also to provide a method for producing the toner.

A toner of the present invention includes core particles formed by mixing and aggregating in an aqueous medium at least a resin particle dispersion in which resin particles are dispersed, a colorant particle dispersion in which colorant particles are dispersed, and a wax particle dispersion in which particles of wax are dispersed. The wax includes at least a first wax and a second wax. An endothermic peak temperature (referred to as a melting point Tmw1 (° C.)) of the first wax by a differential scanning calorimetry (DSC) method is 50° C. to 90° C. An endothermic peak temperature (referred to as a melting point Tmw2 (° C.)) of the second wax by the DSC method is 5° C. to 50° C. higher than Tmw1 of the first wax. Jmw1/Jw1 is 0.5 or less and Jmw2/Jw2 is 0.5 to 1.2, where Jw1 (J/g) represents an endotherm of the first wax by the DSC method, Jw2 (J/g) represents an endotherm of the second wax by the DSC method, Jmw1 (J/g) represents a melting endotherm of the first wax by a modulated differential scanning calorimetry OJDSC) method, and Jmw2 (J/g) represents a melting endotherm of the second wax by the MDSC method. The first wax and the second wax are mixed so as to provide a dispersion beforehand, the dispersion is then mixed with the resin particle dispersion and the colorant particle dispersion, and the particles are aggregated to form the core particles.

A method for producing a toner of the present invention includes forming core particles by mixing and aggregating in an aqueous medium at least a resin particle dispersion in which resin particles are dispersed, a colorant particle dispersion in which colorant particles are dispersed, and a wax particle dispersion in which particles of wax are dispersed. A first wax is selected so that an endothermic peak temperature (referred to as a melting point Tmw1 (° C.)) by a differential scanning calorimetry (DSC) method is 50° C. to 90° C., and a ratio (Jmw1/Jw1) of a melting endotherm Jmw1 (J/g) by a modulated differential scanning calorimetry (MDSC) method to an endotherm Jw1 (J/g) by the DSC method is 0.5 or less. A second wax is selected so that an endothermic peak temperature (referred to as a melting point Tmw2 (° C.)) by the DSC method is 50° C. to 50° C. higher than Tmw1 of the first wax, and a ratio (Jmw2/Jw2) of a melting endotherm Jmw2 (J/g) by the MDSC method to an endotherm Jw2 (J/g) by the DSC method is 0.5 to 1.2. The wax particle dispersion including at least the first wax and the second wax is produced. The wax particle dispersion thus produced is mixed with the resin particle dispersion and the colorant particle dispersion that are produced beforehand, and the particles are aggregated to form the core particles in the aqueous medium.

### BRIEF DESCRIPTION OF DRAWINGS

FIG. 1 is a cross-sectional view showing the configuration of an image forming apparatus used in an example of the present invention.

FIG. 2 is a cross-sectional view showing the configuration of a fixing unit used in an example of the present invention.

FIG. 3 is a schematic view showing a stirring/dispersing device used in an example of the present invention.

FIG. 4 is a plan view of the stirring/dispersing device used in an example of the present invention.

FIG. 5 is a schematic view showing a stirring/dispersing device used in an example of the present invention.

FIG. 6 is a plan view of the stirring/dispersing device used in an example of the present invention.

FIG. 7A is a graph showing a DSC endothermic curve of a toner base in an example of the present invention.

FIG. 7B is a graph showing a MDSC endothermic curve of a toner base in an example of the present invention.

FIG. 8A is a graph showing a DSC endothermic curve of a toner base in an example of the present invention.

FIG. 8B is a graph showing a MDSC endothermic curve of a toner base in an example of the present invention.

FIG. 9A is a graph showing a DSC endothermic curve of a toner base in a comparative example.

FIG. 9B is a graph showing a MDSC endothermic curve of a toner base in a comparative example.

FIG. 10A is a graph showing a DSC endothermic curve of a toner base in a comparative example.

FIG. 10B is a graph showing a MDSC endothermic curve of a toner base in a comparative example.

FIG. 11A is a graph showing a DSC endothermic curve of a toner base in a comparative example.

FIG. 11B is a graph showing a MDSC endothermic curve of a toner base in a comparative example.

### BEST MODE FOR CARRYING OUT THE INVENTION

The present invention can reduce the presence of wax particles, resin particles, and colorant particles that are not aggregated but suspended in the aqueous medium, and thus prevent the core particles to which the wax is added from being coarser. Accordingly, the present invention can produce toner base particles including the core particles that have a small and substantially uniform particle size without requiring a classification process. Moreover, the present invention can provide a toner that is capable of achieving uniform dispersion even if a low melting point wax is added and preventing filming on a photoconductive member or fusion of the toner components on a carrier. The toner of the present invention also can maintain the storage stability while improving the low-temperature fixability, transmittance, glossiness, and high-temperature offset resistance. A tandem color process uses a plurality of image forming stations, each of which includes a photoconductive member and a developing unit, and the transfer process is performed by successively transferring each color of toner to a transfer member. The use of the toner of the present invention in such a tandem color process can suppress transfer voids or reverse transfer and ensure high transfer efficiency.

Hereinafter, each process will be described.

(1) Polymerization and Aggregation Processes

A resin particle dispersion is prepared by forming resin particles of a homopolymer or copolymer (vinyl resin) of vinyl monomers by emulsion or seed polymerization of the vinyl monomers in a surface-active agent and dispersing the resin particles in the surface-active agent. Any known dispersing devices such as a high-speed rotating emulsifier, a high-pressure emulsifier, a colloid-type emulsifier, and a ball mill, sand mill, and Dyno mill that use a medium can be used.

Examples of a polymerization initiator include azo- or diazo-based initiators such as 2,2′-azobis-(2,4-dimethylvaleronitrile), 2,2′-azobisisobutyronitrile, 1,1′-azobis(cydohexane-1-carbonitrile), 2,2′-azobis-4-methoxy-2,4-dimethylvaleronitrile, and azobisisobutyronitrile, persulfates (a potassium persulfate, an ammonium persulfate, etc.), azo compounds (4,4′-azobis-4-cyanovaleric acid and its salt, 2,2′-azobis(2-amidinopropane) and its salt, etc.), and peroxide compounds.

A colorant particle dispersion is prepared by adding colorant particles in water that contains a surface-active agent and dispersing the colorant particles using the above dispersing device.

A wax particle dispersion is prepared by adding wax particles in water that contains a surface-active agent and dispersing the wax particles using the dispersing device.

The toner is required to achieve fixing at lower temperatures, high-temperature offset resistance in the oilless fixing (no silicone oil etc. is applied to the fixing roller), separability of paper from the fixing roller, high transmittance of color images, and storage stability at high temperatures. These requirements should be satisfied at the same time.

For this reason, the wax can be added to improve the low-temperature fixability and the high-temperature offset resistance, and also to avoid a separation failure that occurs when the toner on a transfer medium such as copy paper is melted during fixing and thus reduced releasability from a heating roller, and this transfer medium is not separated from the heating roller. These functions relate to the opposing characteristics. Therefore, it is preferable to use a plurality of types of waxes. By adding a plurality of types of waxes that differ in melting point or skeleton depending on the function of each wax in the toner, it is preferable to ensure the compatibility between the low-temperature fixing and the release agent.

A first embodiment of the toner of the present invention includes forming core particles by mixing and aggregating in an aqueous medium at least a resin particle dispersion in which resin particles are dispersed, a colorant particle dispersion in which colorant particles are dispersed, and a wax particle dispersion in which particles of wax are dispersed. In this case, the wax includes at least a first wax and a second wax. The endothermic peak temperature (referred to as a melting point Tmw1 (° C.)) of the first wax by the DSC method is 50° C. to 90° C., and the endothermic peak temperature (referred to as a melting point Tmw2 (° C.)) of the second wax by the DSC method is 5° C. to 50° C. higher than Tmw1 of the first wax. In the toner produced, assuming that Jw1 (J/g) represents the endotherm of the first wax and Jw2 (J/g) represents the endotherm of the second wax by the DSC method, and that Jmw1 (J/g) represents the melting endotherm of the first wax and Jmw2 (J/g) represents the melting endotherm of the second wax by the MDSC method, there is a specific relationship between the endotherm in the DSC method and the melting endotherm in the MDSC method. The relationship is such that Jmw1/Jw1 is 0.5 or less and Jmw2/Jw2 is 0.5 to 1.2. Preferably, Jmw1/Jw1 is 0.4 or less and Jmw2/Jw2 is 0.6 to 1.0. More preferably, Jmw1/Jw1 is 0.3 or less and Jmw2/Jw2 is 0.7 to 1.0. Further preferably, Jmw1/Jw1 is 0.2 or less and Jmw2/Jw2 is 0.7 to 1.0.

When the waxes with different melting points are used, their functions are separated, and thus both the low-temperature fixing and the high-temperature offset resistance can be ensured, providing the characteristics in a wide fixing temperature range. However, due to the use of the waxes with different melting points, aggregates consisting of either the wax particles having a low melting point or the wax particles having a high melting point are likely to be generated in the aqueous medium. Therefore, the wax dispersion in the individual core particles tends to be uneven. Moreover, since the wax particles that are not aggregated with the resin particles and the colorant particles remain in the core particle dispersion, the core particles are prone to have a broad particle size distribution or a non-uniform shape.

The present inventors found out that the formation of core particles having a small particle size and a narrow particle size distribution, low-temperature fixing, and high-temperature offset resistance were able to be achieved together. When the waxes with different melting points are aggregated with the resin and the colorant to form toner particles in the aqueous medium, it is possible to suppress the presence of suspended wax particles that are not incorporated into the core particles, and also to prevent the particle size distribution of the core particles from being broader. First, in the DSC method, a sample to be measured and a reference material (alumina) are heated simultaneously in a heating furnace at a predetermined heating rate (dT/dt). The temperature difference between the sample and the reference material is detected by a thermal sensor, and a difference between the amount of heat supplied to the sample and the amount of heat supplied to the reference material per unit time is recorded as a temperature function (dH/dt). This function is expressed generally by the following formula.

dH/dt=Cp(dT/dt)+f(T,t)

where H represents enthalpy and its time function dH/dt represents a heat flow in a differential scanning calorimeter (DSC), Cp represents a heat capacity of the sample, T represents a temperature, dT/dt (DC/min) represents a heating rate, and f(T, t) represents an endotherm depending on time and absolute temperature.

In the above formula, the first term of the right-hand side is a heat flow (i.e., the amount of heat per unit time) expressed by the product of the heat capacity and the heating rate, and the glass transition point, specific heat, and heat flow caused by melting of the sample correspond to this term.

The second term of the right-hand side is a heat flow (the endotherm) that does not depend on the heat capacity and the heating rate, namely a heat flow expressed by the function of temperature and time. If the heat flow (the endotherm) of the second term is larger than that of the first term, it is difficult to measure the heat flow due to the glass transition or the like, as indicated by the first term.

In the DSC method, the endotherm (referred to as Jm (J/g)) of the sample can be obtained by integrating a DSC signal (dH/dt (W/g)) with respect to time.

Next, in the MISC method, the heat flow is measured by periodically changing the heating rate. Therefore, the glass transition point, specific heat, and heat flow caused by melting of the sample can be measured selectively, except for the heat flow that does not depend on the heat capacity of the sample. The MDSC method is described in detail, e.g., in JP 8 (1996)-178878 A. Specifically, the minimum value of the heating rate is represented by dT/dt₁ (° C./min), the maximum value of the heating rate is represented by dT/dt₂ (° C./min), and a difference in heat flow between the minimum and maximum heating rates is determined, thereby removing the second term of the right-hand side that does not depend on the heating rate. This can be expressed by the following formula.

AdHm/dt=Cp(dT/dt₁−dT/dt₂)

In the MDSC method, the melting endotherm (referred to as Jmw (J/g)) of the sample can be obtained in the following manner: determining a heat flow (MDSC signal (dHm/dt (W/g)) by multiplying the heat capacity Cp by a mean value of the heating rate; and integrating the heat flow with respect to time. According to the MDSC method, a phenomenon in which the melting endotherm is reduced relative to the endotherm in the DSC method is attributed to a thermal relaxation phenomenon.

The resin particles and the wax particles are heat-treated during the aggregation reaction of the toner, and the core particles are formed while the molten wax particles are mixed or compatible with the molten resin particles. In this state, the core particles are cooled and solidified.

By heating the toner particles in each of which the wax and the resin are mixed or compatible, the endothermic phenomenon of the wax can be a thermal relaxation phenomenon. It is assumed that the endotherm of the wax remelted can be detected with the DSC signal (dH/dt (W/g)), but cannot be detected with the MDSC signal (dHm/dt (W/g)), since the endothermic process by remelting is the thermal relaxation phenomenon.

In other words, when the resin and the wax are mixed and compatible, the endotherm cannot be detected with the MDSC signal. When the toner includes the wax in the crystalline state, the endotherm may be detected with both the MDSC signal and the DSC signal.

If Jmw1/Jw1 is more than 0.5, the first wax in the crystalline state is likely to be increased in the toner. Consequently, the number of the wax particles that are suspended rather than aggregated is increased, and the particle size distribution of the core particles tends to be broader. Moreover, the effect of reducing the glass transition point and the softening point of the core particles due to the compatibility of the wax with the resin is weak, and thus a contribution to the low-temperature fixability is likely to be lower. As the first wax that has a low melting point and is in the crystalline state is increased, the storage stability of the toner is degraded when it is allowed to stand at high temperatures.

If Jmw2/Jw2 is less than 0.5, the mixing process proceeds at the molecular level of the second wax, so that the high-temperature offset resistance of the second wax is impaired.

If Jmw2/Jw2 is more than 1.2, the second wax is present individually in the toner particles, and the core particles are likely to be coarser.

As an example, the Jmw2/Jw2 ratio of the endotherm in the MDSC method to the endotherm in the DSC method is 1.0 or more for the following reasons. When the wax absorbs heat, it may form an energetically stable structure and generate heat. This heat generation is a reduction in thermal relaxation. In the DSC method, the endotherm is canceled out by the heat generation of the wax, and therefore the apparent endotherm is reduced. In the MDSC method, such heat generation is not detected. Accordingly, when the wax generates heat, the Jmw/Jw ratio of the endotherm in the MDSC method to the endotherm in the DSC method is 1.0 or more.

When the resin particles, the colorant particles, and the wax particles are mixed and aggregated to form the core particles, the aggregation reaction is performed by increasing the temperature of the aqueous medium to 70° C. to 95° C. Therefore, the wax having a melting point of 50° C. to 90° C. is melted to a large extent at the above aggregation temperature, and thus can be aggregated with the resin particles in several hours (1 to 5 hours). Under these conditions, the resin and the wax are mixed or compatible easily, so that Jmw1/Jw1 may tend to be a small value. Thus, it may be possible to suppress the number of the wax particles that are suspended rather than aggregated, to accelerate the aggregation reaction for the core particles, and to form the core particles having a small particle size and a narrow particle size distribution. Moreover, the compatibility of the wax with the resin may have the effect of reducing the glass transition point and the softening point of the core particles, and thus can contribute to the low-temperature fixability.

The melting point of the first wax is preferably 55° C. to 85° C., more preferably 58° C. to 85° C., and further preferably 68° C. to 74° C. If the melting point is lower than 50° C., the aggregation proceeds too fast, and the core particles are likely to be coarser. Moreover, the storage stability at high temperatures is degraded. If the melting point is higher than 90° C., the low-temperature fixability and the color glossiness are not improved. Since the melting point of the second wax is at least 5° C. higher than Tmw1 of the first wax, the second wax melts more slowly than the first wax during the aggregation reaction. Therefore, it is considered that the proportion of the second wax in the crystalline state in the toner is increased, and the value of Jmw2/Jw2 is not reduced.

The use of the second wax having a melting point of at least 5° C. higher than the melting point Tmw1 of the first wax can separate the functions of the waxes efficiently, and thus can ensure the low-temperature fixability, the high-temperature offset resistance, and the separability of paper together.

Tmw2 of the second wax is more preferably 10° C. to 40° C., and further preferably 15° C. to 35° C. higher than Tmw1. Thus, the functions of a plurality of waxes can be separated efficiently, so that the low-temperature fixability, the high-temperature offset resistance, and the separability of paper can be ensured together. If the temperature difference is less than 5° C., it is difficult to exhibit the effects of the low-temperature fixability, the high-temperature offset resistance, and the separability of paper. If the temperature difference is more than 50° C., the first and second waxes are phase-separated and not incorporated uniformly into the toner particles.

As a first preferred example of using a plurality of waxes, the wax may include at least the first wax and the second wax, the endothermic peak temperature (referred to as a melting point Tmw1 (° C.)) of the first wax by the DSC method may be 50° C. to 90° C., and the endothermic peak temperature (referred to as a melting point Tmw2 (° C.)) of the second wax by the DSC method may be 80° C. to 120° C.

In this case, Tmw1 of the first wax is preferably 55° C. to 85° C., more preferably 60° C. to 85° C., and further preferably 65° C. to 75° C. If Tmw1 is lower than 50° C., the core particles are likely to be coarser. Moreover, the storage stability is degraded. If Tmw1 is higher than 90° C., the low-temperature fixability and the color glossiness are not improved.

Tmw2 of the second wax is preferably 80° C. to 120° C., more preferably 85° C. to 100° C., and further preferably 90° C. to 100° C. If Tmw2 is lower than 80° C., the high-temperature offset resistance and the separability of paper are weakened. If Tmw2 is higher than 120° C., the aggregation of the wax is reduced, the numbers of suspended wax particles are increased in the aqueous medium, and the particle shape is likely to be non-uniform.

As a second preferred example of using a plurality of waxes, the wax may include at least the first wax and the second wax, the first wax may include an ester wax composed of at least one of a higher alcohol having a carbon number of 16 to 24 and a higher fatty acid having a carbon number of 16 to 24, and the second wax may include an aliphatic hydrocarbon wax.

As a third preferred example of using a plurality of waxes, the wax may include at least the first wax and the second wax, the first wax may include a wax having an iodine value of not more than 25 and a saponification value of 30 to 300, and the second wax may include an aliphatic hydrocarbon wax. The iodine value of the first wax is preferably 1 to 25, and more preferably 1 to 10.

In the second and third preferred examples, the endothermic peak temperature (melting point Tmw1 (° C.)) of the first wax by the DSC method is 50° C. to 90° C., preferably 55° C. to 85° C., more preferably 58° C. to 85° C., and further preferably 68° C. to 74° C. If Tmw1 is lower than 50° C., the storage stability and the heat resistance of the toner are degraded. If Tmw1 is higher than 90° C., the aggregation of the wax is reduced, and the numbers of suspended wax particles are increased in the aqueous medium. Moreover, the low-temperature fixability and the glossiness are not improved.

The endothermic peak temperature (melting point Tmw2 (° C.)) of the second wax by the DSC method is 80° C. to 120° C., preferably 85° C. to 100° C., and more preferably 90° C. to 100° C. If Tmw2 is lower than 80° C., the storage stability is degraded, and the high-temperature offset resistance and the separability of paper are weakened. If Tmw2 is higher than 120° C., the aggregation of the wax is reduced, and the numbers of suspended wax particles are increased in the aqueous medium. Moreover, the low-temperature fixability and the color transmittance are impaired.

In the second or third preferred example, when the resin, the colorant, and the aliphatic hydrocarbon wax are mixed to form core particles in the aqueous medium, the aliphatic hydrocarbon wax is unlikely to be aggregated with the resin due to its low affinity with the resin. Therefore, the aliphatic hydrocarbon wax is not incorporated into the molten core particles, and the wax particles are suspended in the aqueous medium. Such presence of the suspended wax particles may hinder the progress of aggregation for the core particles and make the particle size distribution broader.

However, if the temperature or time of the heat treatment is changed to reduce the suspended particles or to prevent a broad particle size distribution, the particle size is increased. Moreover, when second resin particles further are added to the molten core particles to form a shell, as will be described later, secondary aggregation of the core particles occurs rapidly, and the particles become coarser.

By using the wax that includes the first wax including a specified wax and the second wax including a specified aliphatic hydrocarbon wax, it is possible to suppress the presence of suspended aliphatic hydrocarbon wax particles that are not incorporated into the core particles, and also to prevent the particle size distribution of the core particles from being broader. This may be because in the heating and aggregation processes the first wax continues to be compatible with the resin, which promotes aggregation of the aliphatic hydrocarbon wax and the resin, and therefore the waxes are incorporated uniformly. Thus, the values of Jmw1/Jw1 and Jmw2/Jw2 fall in the predetermined ranges, respectively.

In the heating and aggregation processes, it is assumed that the first wax continues to be compatible with the resin, which promotes aggregation of the aliphatic hydrocarbon wax i.e., the second wax) and the resin, and therefore the waxes are incorporated uniformly, and the presence of suspended wax particles can be suppressed.

When the first wax is partially compatible with the resin, the low-temperature fixability is likely to be improved further. The aliphatic hydrocarbon wax i.e., the second wax) is not compatible with the resin, and thus can have the function of improving the high-temperature offset resistance. In other words, the first wax may function as both a dispersion assistant for emulsifying and dispersing the aliphatic hydrocarbon wax and a low-temperature fixing assistant.

To control the values of Jmw1/Jw1 and Jmw2/Jw2 within the predetermined numerical ranges, the material composition may include the following configurations: a) each of the first and second waxes has an endothermic peak temperature in the predetermined range; b) the first wax includes the specified ester wax, and the second wax includes the aliphatic hydrocarbon wax; and c) the molecular weight characteristics of the resin particles included in the core particles are defined, and particularly the value of Mw/Mn is made smaller.

In the first, second, or third example using a plurality of waxes, it is preferable that FT2/ES1 is 0.2 to 10, and more preferably 1 to 9, where ES1 and FT2 are weight ratios of the first wax and the second wax to 100 parts by weight of the wax in the wax particle dispersion, respectively. If FT2/ES1 is less than 0.2, the effect of the high-temperature offset resistance cannot be obtained, and the storage stability is degraded. If FT2/ES1 is more than 10, the low-temperature fixing cannot be achieved, and the particle size distribution of the core particles tends to be broader. Moreover, FT2 of 50 wt % or more is a well-balanced ratio at which the low-temperature fixability, the high-temperature storage stability, and the high-temperature offset resistance can be ensured together.

The total amount of the wax added is preferably 5 to 30 parts by weight, more preferably 8 to 25 parts by weight, and further preferably 10 to 20 parts by weight per 100 parts by weight of the resin. If the amount is less than 5 parts by weight, the effects of the low-temperature fixability and the releasability cannot be obtained. If the amount is more than 30 parts by weight, it is difficult to control the particles with a small particle size.

In the first, second, or third example using a plurality of waxes, the waxes with different melting points are aggregated with the resin and the colorant in the aqueous medium to form core particles. In this case, when a dispersion obtained by emulsifying and dispersing the first wax and the second wax separately is mixed with the resin particle dispersion and the colorant particle dispersion, and then this mixed dispersion is heated and aggregated, the first wax and the resin particles form the core particles, while the second wax is not incorporated into the core particles and is likely to be suspended because of a difference in melting rate between the first wax and the second wax. Consequently, the particle size distribution tends to be broader, and it may be difficult to form particles having a small particle size and a narrow particle size distribution. Moreover, when a shell layer is formed, secondary aggregation of the core particles may occur rapidly, and the particles may become coarser. Such a problem also cannot be solved satisfactorily. In the case of using the dispersion obtained by emulsifying and dispersing the first wax and the second wax separately, Jmw1/Jw1 is increased to 0.7 to 0.8 and Jmw2/Jw2 is likely to be in the range of 0.8 to 1.4.

Thus, it is preferable that the wax particle dispersion is produced by mixing, emulsifying, and dispersing the first wax and the second wax concurrently. In this case, the first wax and the second wax may be mixed at a predetermined mixing ratio, and then heated, emulsified, and dispersed in an emulsifying and dispersing device. The first wax and the second wax may be put in the device either separately or simultaneously. However, it is preferable that the wax particle dispersion thus produced includes the first wax and the second wax in the mixed state. With this configuration, Jmw1/Jw1 is even smaller than 0.5 and Jmw2/Jw2 is not likely to be changed.

If the wax is treated with an anionic surface-active agent, the core particles become coarser during the aggregation process, and it may be difficult to obtain particles having a sharp particle size distribution. This phenomenon is likely to occur particularly in forming the core particles by mixing the hydrocarbon wax and the ester wax.

Therefore, it is preferable that the wax particle dispersion is produced by mixing, emulsifying, and dispersing the first wax and the second wax with a surface-active agent that includes a nonionic surface-active agent (nonion) as the main component. When the wax is mixed and dispersed with the surface-active agent that includes a nonionic surface-active agent as the main component to produce an emulsion dispersion, aggregation of the wax particles themselves can be suppressed, and the dispersion stability can be improved. The wax particle dispersion thus obtained is mixed with the resin particle dispersion and the colorant particle dispersion, so that the core particles having a small particle size and a narrow sharp particle size distribution can be formed without the liberation of the waxes. The nonionic surface-active agent is preferably 50 to 100 wt %, and more preferably 60 to 100 wt % of the total surface-active agent.

As a preferred example of forming the core particles, the resin particle dispersion in which the resin particles are dispersed, the colorant particle dispersion in which the colorant particles are dispersed, and the wax particle dispersion in which the wax particles are dispersed are mixed in the aqueous medium. The pH of this mixed dispersion is adjusted under the predetermined conditions. Then, a water-soluble inorganic salt is added to the mixed dispersion, so that the resin particles, the colorant particles, and the wax particles are aggregated to form the core particles. Subsequently, the aqueous medium is heated to not less than the glass transition point (Tg) of the resin particles and/or the melting point of the wax, thereby forming the core particles, at least part of which is melted.

When persulfate (e.g., potassium persulfate) is used as a polymerization initiator in the emulsion polymerization of the resin to prepare a resin particle dispersion, the residue may be decomposed by heat applied during the aggregation process and may change (reduce) the pH of the mixed dispersion. Therefore, it is preferable that a heat treatment of the resin particle dispersion is performed at temperatures not less than a predetermined temperature (preferably 80° C. or more for sufficient decomposition of the residue) for a predetermined time (preferably about 1 to 5 hours) after the emulsion polymerization.

The pH of the mixed dispersion is adjusted preferably in the range of 9.5 to 12.2, more preferably in the range of 10.5 to 12.2, and further preferably in the range of 11.2 to 12.2. In this case, 1N NaOH can be used for the pH adjustment. When the pH value is 9.5 or more, the core particles produced can be prevented from being coarser. When the pH value of 12.2 or less, it is possible to suppress the generation of liberated wax particles or colorant particles, and also to facilitate uniform incorporation of the wax or colorant particles.

After the pH of the mixed dispersion is adjusted, the water-soluble inorganic salt is added to the mixed dispersion, and then the mixed dispersion is heat-treated so that at least the first resin particles, the colorant particles, and the wax particles are aggregated to form the core particles, at least part of which is melted. The core particles have a predetermined volume-average particle size. The pH of the liquid at the time of forming the core particles with a predetermined volume-average particle size is maintained in the range of 7.0 to 9.5. This can reduce the liberation of the wax and thus allows the core particles incorporating the wax to have a narrow particle size distribution. The amount of NaOH added, the type or amount of aggregating agent, the pH values of the emulsion-polymerized resin dispersion, the colorant dispersion and the wax dispersion, a heating temperature, or time may be selected appropriately. If the pH of the liquid is less than 7.0 at the time of forming the core particles, the core particles become coarser. If the pH of the liquid is more than 9.5, the amount of suspended wax particles is increased due to poor aggregation.

When persulfate (e.g., potassium persulfate) is used as a polymerization initiator in the emulsion polymerization of the resin to prepare a resin particle dispersion, the residue may be decomposed by heat applied during the aggregation process and may change reduce) the pH of the mixed dispersion. Therefore, it is preferable that a heat treatment of the resin particle dispersion is performed at temperatures not less than a predetermined temperature (preferably 80° C. or more for sufficient decomposition of the residue) for a predetermined time (preferably about 1 to 5 hours) after the emulsion polymerization. It is preferably 4 or less, and more preferably 1.8 or less.

The pH (hydrogen ion concentration) may be measured in the following manner. A sample (the liquid to be measured) is taken out from a liquid tank in an amount of 10 ml with a pipet and put into a beaker having approximately the same capacity. Then, this beaker is immersed in cold water, and the sample is cooled to room temperature (30° C. or less). Using a pH meter (SevenMulti manufactured by Mettler-Tolede Inc.), a measuring probe is dipped into the sample that has been cooled to room temperature. When the display of the meter is stabilized, the numerical value is read as a pH value.

After adjusting the pH of the mixed dispersion, the liquid temperature of the mixed dispersion is raised while stirring. The rate of temperature rise is preferably 0.1 to 10° C./min. If it is too slow, the productivity is reduced. If it is too fast, the particle surface has not been smooth before the particles become spherical in shape.

As a more preferred example of forming the core particles, the resin particle dispersion, the colorant particle dispersion, and the wax particle dispersion are mixed in the aqueous medium to produce a mixed dispersion. Then, the mixed dispersion is heated, and after the liquid temperature of the mixed dispersion reaches a predetermined temperature, a water-soluble inorganic salt may be added to the mixed dispersion as an aggregating agent.

The core particles may be formed by mixing the mixed dispersion and an aggregating agent beforehand, and heating the mixed dispersion so that the temperature is increased to not less than the glass transition point of the resin. In this method, however, the aggregation reaction occurs slowly with temperature-rising time, and therefore it is difficult to produce particles having a small particle size and a narrow particle size distribution. Moreover, the aggregation state of the particles in the process of aggregation is likely to vary, so that the particle size distribution of the particles obtained by aggregation and fusion may become broader, and the surface properties of toner particles as a final product may be changed. In particular, the particle size distribution and the surface properties tend to be affected by the wax and the colorant used.

In the case where the waxes with different melting points are used concurrently, the wax particles having a low melting point start to melt earlier and are aggregated with each other while the temperature is raised. As the temperature becomes higher, the wax particles having a high melting point start to melt next and are aggregated with each other. Therefore, aggregates consisting of either the wax particles having a low melting point or the wax particles having a high melting point are likely to be generated, and the wax dispersion in the individual core particles tends to be uneven. Moreover, the core particles are prone to have a broad particle size distribution or a non-uniform shape.

When the aggregating agent is added after the temperature of the mixed dispersion reaches a predetermined temperature or more, a phenomenon in which the aggregation occurs slowly with temperature-rising time can be avoided, and the aggregation reaction proceeds rapidly along with the addition of the aggregating agent. Thus, the core particles can be formed in a short time. The values of Jmw1/Jw1 and Jmw2/Jw2 fall in the predetermined ranges, respectively. Moreover, it is possible to form the core particles that incorporate the wax and the colorant uniformly, and have a small particle size and a narrow particle size distribution.

As the aggregating agent to be added, an aqueous solution containing a water-soluble inorganic salt with a predetermined water concentration may be used. It is also preferable that the pH value of the aqueous solution is adjusted, and subsequently the aqueous solution is added to the mixed dispersion containing at least the first resin particle dispersion, the colorant particle dispersion, and the wax particle dispersion.

By adjusting the pH value of the aqueous solution containing the aggregating agent to a predetermined value, the aggregation action of particles as the aggregating agent may be improved further. It is preferable that there is a certain relationship between the pH values of the aqueous solution and the mixed dispersion. If the aggregating agent aqueous solution whose pH value is different from that of the mixed dispersion is added to the mixed dispersion, the pH balance of the liquid is disturbed suddenly. As a result, the aggregated particles become coarser, and the dispersion of the wax particles tends to be uneven. To suppress such phenomena, the pH adjustment of the aggregating agent aqueous solution is effective.

When the pH value of the mixed dispersion (including the resin particle dispersion, the colorant particle dispersion, and the wax particle dispersion) before the heat treatment and the addition of the aggregating agent aqueous solution is identified as HG, it is preferable that the aggregating agent aqueous solution is added with the pH value being adjusted in the range of HG+2 to HG−4. The range is preferable HG+2 to HG−3, more preferably HG+1.5 to HG−2, and further preferably HG+1 to HG−2.

If the aggregating agent aqueous solution whose pH value is different from that of the mixed dispersion is added to the mixed dispersion, the pH balance of the liquid is disturbed suddenly. As a result, there are some cases where the aggregation reaction slows and proceeds with difficulty, or the aggregated particles are likely to be coarser. To suppress such phenomena, the pH adjustment of the aggregating agent aqueous solution is effective. Although the reason is unclear, it may be more preferable that the pH value of the aqueous solution containing the aggregating agent is made lower than that of the mixed dispersion.

When the pH is HG−4 or more, the aggregation action of particles as the aggregating agent is improved further, and thus the aggregation reaction can be accelerated. When the pH is HG+2 or less, it is possible to suppress phenomena in which the aggregated particles become coarser, or the particle size distribution becomes broader.

It is preferable that the aggregating agent is added after the temperature of the mixed dispersion (including the resin particle dispersion, the colorant particle dispersion, and the wax particle dispersion) reaches a melting point or more of the wax measured by the DSC method, which will be described later. When the aggregating agent is added while the wax has started to melt, the molten wax particles, the resin particles, and the colorant particles are aggregated rapidly. Further, the continuation of the heat treatment can promote the melting of the wax particles and the resin particles, and thus the particle formation can be carried out.

In this case, even if the aggregating agent is added at the time the temperature of the mixed dispersion reaches a glass transition point of the first resin particles, the particles hardly are aggregated, and thus the particle formation cannot be carried out. By adding the aggregating agent at the time the temperature of the mixed dispersion reaches a specific temperature of the wax, the aggregation of the particles proceeds, and then the mixed dispersion is heat-treated for 0.5 to 5 hours, preferably 0.5 to 3 hours, and more preferably 1 to 2 hours, thus forming the core particles with a predetermined particle size distribution. The values of Jmw1/Jw1 and Jmw2/Jw2 fall in the predetermined ranges, respectively.

Although the heat treatment may be performed while maintaining the specific temperature of the wax, the mixed dispersion is heated preferably at 80° C. to 95° C., and more preferably at 90° C. to 95° C. The aggregation reaction can be accelerated to shorten the treatment time.

When two or more types of waxes are included, as will be described later, the temperature of the mixed dispersion is adjusted preferably to the specific temperature of the wax having a lower melting point, and more preferably to the specific temperature of the wax having a higher melting point. It is effective to add the aggregating agent at the temperature at which the wax particles have started to melt.

Although the entire amount of the aggregating agent may be added collectively, it is preferable that the aggregating agent is dropped over 1 to 120 minutes. The dropping may be performed intermittently, but continuous dropping is preferred. By dropping the aggregating agent at a constant rate into the heated mixed dispersion, the aggregating agent is mixed gradually and uniformly with the whole mixed dispersion in the reactor. This can prevent the particle size distribution from being broader due to uneven distribution, and also can suppress the generation of suspended particles of the wax and the colorant. Moreover, it is possible to suppress a rapid decrease in liquid temperature of the mixed dispersion. The drop time is preferably 5 to 60 minutes, more preferably 10 to 40 minutes, and further preferably 15 to 35 minutes. When the drop time is 1 minute or more, the core particles are not excessively irregular in shape and can have a stable shape. When the drop time is 120 minutes or less, the presence of the colorant or wax particles that are suspended independently because of aggregation failure can be suppressed.

The aggregating agent is dropped in an amount of 1 to 50 parts by weight, preferably 1 to 20 parts by weight, more preferably 5 to 15 parts by weight, and further preferably 5 to 10 parts by weight per 100 parts by weight of the sum total of the resin particles, the colorant particles, and the wax particles. If the amount of the aggregating agent is small, the aggregation reaction does not proceed. If the amount of the aggregating agent is too large, the particles produced are likely to be coarser.

The mixed dispersion also may include ion-exchanged water other than the first resin particle dispersion, the colorant particle dispersion, and the wax particle dispersion so as to adjust the solid concentration in the liquid. The solid concentration in the liquid is preferably 5 to 40 wt %.

As the aggregating agent, it is also preferable to use the water-soluble inorganic salt after being adjusted to a predetermined concentration with ion-exchanged water or the like. The concentration of the aggregating agent aqueous solution is preferably 5 to 50 wt %.

As a more preferred example of forming the core particles, when the resin particle dispersion in which the resin particles are dispersed, the colorant particle dispersion in which the colorant particles are dispersed, and the wax particle dispersion in which the wax particles are dispersed are mixed, and the particles are aggregated to form the core particles, the main component of the surface-active agent used for the resin particle dispersion is a nonionic surface-active agent, and the main component of the surface-active agent used for each of the colorant particle dispersion and the wax particle dispersion is a nonionic surface-active agent. In the context of the present invention, the “main component” is defined as 50 wt % or more of the surface-active agent used.

In the surface-active agent used for the resin particle dispersion, the nonionic surface-active agent is preferably 50 to 95 wt %, more preferably 55 to 90 wt %, and further preferably 60 to 85 wt % of the total surface-active agent.

In the surface-active agent used for each of the colorant particle dispersion and the wax particle dispersion, the nonionic surface-active agent is preferably 50 to 100 wt %, more preferably 60 to 100 wt %, and further preferably 60 to 90 wt % of the total surface-active agent.

Moreover, among the surface-active agents used for each of the particle dispersions, it is preferable that the weight ratio of the nonionic surface-active agent to the total surface-active agent is larger in the colorant particle dispersion or the wax particle dispersion than in the resin particle dispersion. With this configuration, first, the resin particles start to be aggregated to form nuclei. Then, the wax particles or the colorant particles start to be aggregated around each of the nuclei of the resin particles. The resin particles are added generally in a weight concentration several times higher than the colorant particles or the wax particles. Therefore, the nuclei consisting of the resin particles are aggregated further onto the wax particles, so that the toner whose outermost surface is covered with the resin can be provided easily. Moreover, it may be possible to eliminate the presence of the colorant or wax particles that are not aggregated but suspended in the aqueous medium, and to form the core particles having a small particle size and a uniform, narrow and sharp particle size distribution.

It is also preferable that the surface-active agent used for the resin particle dispersion is a mixture of a nonionic surface-active agent and an ionic surface-active agent, and the main component of the surface-active agent used for each of the wax particle dispersion and the colorant particle dispersion is only a nonionic surface-active agent.

Using the resin particles, the colorant particles, and the wax particles as described in the above example, when the aggregating agent is allowed to act on these particles in the aqueous medium, first, the resin particles start to be aggregated to form nuclei. Then, the wax particles and the colorant particles start to be aggregated around each of the nuclei of the resin particles. The resin particles are added generally in a weight concentration several times higher than the colorant particles or the wax particles. Therefore, the nuclei consisting of the resin particles are aggregated further onto the wax particles, so that the toner whose outermost surface is covered with the resin may be provided. Such a mechanism may make it possible to eliminate the presence of the colorant or wax particles that are not aggregated but suspended in the aqueous medium, and to form the core particles having a small particle size and a uniform, narrow and sharp particle size distribution.

In the surface-active agent used for the resin particle dispersion, the nonionic surface-active agent is preferably 50 to 95 wt %, more preferably 55 to 90 wt %, and further preferably 60 to 85 wt % of the total surface-active agent. When the nonionic surface-active agent is 50 wt % or more, the particle size distribution of the particles produced can be prevented from being broader. When the nonionic surface-active agent is 95 wt % or less, the dispersion of the resin particles themselves can be stabilized in the resin particle dispersion. An anionic surface-active agent is preferred as the ionic surface-active agent.

As described above, the values of Jmw1/Jw1 and Jmw2/Jw2 can be controlled within the predetermined numerical ranges, respectively by taking the following measures: a) the wax particle dispersion is produced by mixing, emulsifying, and dispersing the first wax and the second wax concurrently; b) the mixed dispersion containing the resin particle dispersion, the colorant particle dispersion, and the wax particle dispersion is heated, and after the liquid temperature of the mixed dispersion reaches a predetermined temperature, a water-soluble inorganic salt is added to the mixed dispersion as an aggregating agent; c) when the core particles are formed, the main component of the surface-active agent used for the resin particle dispersion is a nonionic surface-active agent, and the main component of the surface-active agent used for each of the colorant particle dispersion and the wax particle dispersion is a nonionic surface-active agent; d) among the surface-active agents used for each of the particle dispersions, the weight ratio of the nonionic surface-active agent to the total surface-active agent is larger in the colorant particle dispersion or the wax particle dispersion than in the resin particle dispersion; and e) the surface-active agent used for the resin particle dispersion is a mixture of a nonionic surface-active agent and an ionic surface-active agent, and the main component of the surface-active agent used for each of the wax particle dispersion and the colorant particle dispersion is only a nonionic surface-active agent.

It is also preferable that a second resin particle dispersion in which second resin particles are dispersed is added to and mixed with the core particle dispersion in which the core particles are dispersed, and the resultant dispersion is heat-treated so that the second resin particles are fused with the core particles, providing toner base particles.

In the toner of the present invention, although the pigment and the wax are incorporated into the toner, there is a possibility that the colorant (e.g., the pigment) and the wax are present on the outermost surface of the toner. These pigment and wax have an adverse effect on the image quality when accumulated in an electrophotographic apparatus. To prevent such a problem, therefore, it is desirable that a fused layer (also referred to as a shell layer) is formed on the individual core particles by fusing the second resin particles with the core particles. Moreover, it is also desirable that the shell layer is formed of resin particles with a high glass transition point (Tg (° C.)) in view of improving the high-temperature storage stability of the toner, or high-molecular-weight emulsified resin particles in view of ensuring the high-temperature offset resistance, or resin particles containing a charge control agent in view of the charge stability.

In an example of fusing the second resin particles with the core particles, the second resin particle dispersion in which the second resin particles are dispersed is added to the core particle dispersion, and the resultant dispersion is heat-treated so that a resin fused layer is formed on the individual core particles by fusing the second resin particles with the core particles. In this case, it is preferable that the second resin particle dispersion is added after adjusting the pH value in a predetermined range. In particular, it is more effective to combine the pH adjustment with the dropping conditions of the second resin particle dispersion.

The addition of the second resin particle dispersion without disturbing the pH balance of the liquid is intended to suppress the generation of the second resin particles that are not fused but suspended, to improve the adhesion of the second resin particles to the core particles, or to suppress the occurrence of secondary aggregation of the core particles.

With regard to the conditions of the pH value of the second resin particle dispersion, when the pH value of the core particle dispersion in which the core particles are dispersed is identified as HS, it is preferable that the second resin particle dispersion is added with the pH value being adjusted in the range of HS+4 to HS−4. The range is preferably HS+3 to HS−3, more preferably HS+3 to HS−2, and further preferably HS+2 to HS−1.

If the second resin particle dispersion whose pH value is different from that of the core particle dispersion is added to the core particle dispersion, the pH balance of the liquid is disturbed suddenly. As a result, there are some cases where the second resin particles do not adhere to the core particles, or the particles produced become coarser due to secondary aggregation of the core particles. To suppress such phenomena, the pH adjustment of the second resin particle dispersion is effective. This can reduce the generation of suspended particles of the second resin particles, so that the second resin particles can adhere uniformly to the surface of the individual core particles. Moreover, the adhesion of the second resin particles to the core particles can be promoted, which makes the fusion time shorter. Thus, the productivity can be improved. During the fusion of the second resin particles with the core particles, the particles can be prevented from becoming coarser rapidly, thereby achieving a small particle size and a sharp particle size distribution. When the pH value is HS+4 or less, it is possible to prevent the particles from being coarser and the particle size distribution from being broader. When the pH value is HS−4 or more, the adhesion of the second resin particles to the core particles can proceed, and the fusion process can be performed in a short time. It is also possible to suppress a phenomenon in which the second resin particles do not fuse but continue to be suspended in the aqueous medium, and the reaction tends not to proceed while the liquid remains white and cloudy.

The pH of the second resin particle dispersion can be adjusted closer to or higher than the pH of the core particle dispersion in which the core particles are dispersed. By adjusting the pH in this range, secondary aggregation of the core particles is allowed to occur partially while the second resin particles are fused with the core particles. Thus, the particle shape can be controlled from spherical particles to potato-shaped particles.

There is a strong tendency to determine the shape of the toner by its compatibility with the development, transfer, and cleaning processes. Therefore, when the importance of the cleaning properties of a photoconductive member or a transfer belt is stressed, a wider tolerance for cleaning can be ensured with the potato-shaped particles than the spherical particles of the toner. When the importance of the transfer properties is stressed, the shape of the toner is close to a sphere so as to improve the transfer efficiency.

In an example of fusing the second resin particles with the core particles, it is preferable that the pH value of the second resin particle dispersion to be added to the core particle dispersion is adjusted in the range of 3.5 to 11.5 regardless of the pH value of the core particle dispersion in which the core particles are dispersed. The range is preferably 5.5 to 11.5, more preferably 6.5 to 11, and further preferably 6.5 to 10.5. When the pH value is 3.5 or more, the adhesion of the second resin particles to the core particles can proceed, and thus it is possible to suppress a phenomenon in which the second resin particles are suspended in the aqueous medium, and the liquid remains white and cloudy. When the pH value is 11.5 or less, the particles produced can be prevented from becoming coarser rapidly.

When the pH of the second resin particle dispersion is adjusted to be higher in the range of HS to HS+4, the occurrence of secondary aggregation of the core particles can be controlled, and the shape of the toner base particles (end product) also can be controlled during the addition of the second resin particles.

In an example of fusing the second resin particles with the core particles, a method for adding the second resin particle dispersion is not particularly limited, and the entire amount of the second resin particle dispersion may be added collectively. Also, the second resin particle dispersion may be added to the core particle dispersion in which the core particles are dispersed at a drop rate of 0.14 parts by weight/min to 2 parts by weight/min, preferably at a rate of 0.15 parts by weight/min to 1 part by weight/min, and further preferably at a rate of 0.2 parts by weight/min to 0.8 parts by weight/min with respect to 100 parts by weight of the core particles produced.

The second resin particle dispersion is added as it is after the core particles reach a predetermined particle size. It is preferable that the addition is performed by successively dropping the second resin particle dispersion. If the entire predetermined amount of the second resin particle dispersion is added collectively, or if the drop rate is more than 2 parts by weight/min, aggregation of only the second resin particles occurs easily, and the particle size distribution tends to be broader. Moreover, when the input of the second resin particle dispersion is increased, the liquid temperature decreases rapidly, and thus the aggregation reaction stops proceeding. As a result, a part of the second resin particles does not adhere to the core particles and may remain suspended in the aqueous medium.

If the drop rate is less than 0.14 parts by weight/min, the amount of the second resin particles adhering to the core particles is reduced. Therefore, aggregation of the core particles themselves may occur as heating continues, and the particles become coarser and the particle size distribution tends to be broader.

By controlling the dropping conditions of the second resin particle dispersion, it is possible to prevent aggregation of the core particles themselves or aggregation of only the second resin particles, and to produce particles having a small size and a narrow particle size distribution.

The second resin particle dispersion is dropped preferably so that a variation in liquid temperature of the core particle dispersion in which the core particles are dispersed can be suppressed within 10%.

The core particles or the core particles fused with the second resin particles may be subjected to cleaning, liquid-solid separation, and drying processes as desired to provide toner base particles. The cleaning process preferably involves sufficient substitution cleaning with ion-exchanged water to improve the chargeability. The liquid-solid separation process is not particularly limited, and any known filtration methods such as suction filtration and pressure filtration can be used preferably in view of productivity. The drying process is not particularly limited, and any known drying methods such as flash-jet drying, flow drying, and vibration-type flow drying can be used preferably in view of productivity.

The water-soluble inorganic salt used in the present invention may be, e.g., an alkali metal salt or alkaline-earth metal salt. Examples of the alkali metal include lithium, potassium, and sodium. Examples of the alkaline-earth metal include magnesium, calcium, strontium, and barium. Among these, potassium, sodium, magnesium, calcium, and barium are preferred. The counter ions (the anions constituting a salt) of the above alkali metals or alkaline-earth metals may be, e.g., a chloride ion, bromide ion, iodide ion, carbonate ion, or sulfate ion.

Examples of the organic solvent with infinite solubility in water include methanol, ethanol, 1-propanol, 2-propanol, ethylene glycol, glycerin, and acetone. Among these, alcohols having a carbon number of not more than 3 such as methanol, ethanol, 1-propanol, and 2-propanol are preferred, and 2-propanol is particularly preferred.

The nonionic surface-active agent may be, e.g., a polyethylene glycol-type nonionic surface-active agent or a polyol-type nonionic surface-active agent. Examples of the polyethylene glycol-type nonionic surface-active agent include a higher alcohol ethylene oxide adduct, alkylphenol ethylene oxide adduct, fatty acid ethylene oxide adduct, polyol fatty acid ester ethylene oxide adduct, fatty acid amide ethylene oxide adduct, ethylene oxide adduct of fats and oils, and polypropylene glycol ethylene oxide adduct. Examples of the polyol-type nonionic surface-active agent include a fatty acid ester of glycerol, fatty acid ester of pentaerythritol, fatty acid ester of sorbitol and sorbitan, fatty acid ester of sucrose, polyol alkyl ether, and fatty acid amide of alkanolamines.

In particular, the polyethylene glycol-type nonionic surface-active agent such as a higher alcohol ethylene oxide adduct or alkylphenol ethylene oxide adduct can be used preferably.

Examples of the aqueous medium include water such as distilled water or ion-exchanged water, and alcohols. They can be used individually or in combinations of two or more. The content of the polar surface-active agent in the dispersing agent having a polarity need not be defined generally and may be selected appropriately depending on the purposes.

In the present invention, when the nonionic surface-active agent is used with the ionic surface-active agent, the polar surface-active agent may be, e.g., a sulfate-based, sulfonate-based, phosphate-based, or soap-based anionic surface-active agent or an amine salt-type or quaternary ammonium salt-type cationic surface-active agent.

Specific examples of the anionic surface-active agent include sodium dodecyl benzene sulfonate, sodium dodecyl sulfate, sodium alkyl naphthalene sulfonate, and sodium dialkyl sulfosuccinate.

Specific examples of the cationic surface-active agent include alkyl benzene dimethyl ammonium chloride, alkyl trimethyl ammonium chloride, and distearyl ammonium chloride. They can be used individually or in combinations of two or more.

(2) Wax

A preferred example of the first wax may include at least one type of ester composed of at least one of a higher alcohol having a carbon number of 16 to 24 and a higher fatty acid having a carbon number of 16 to 24. The use of this wax can suppress the presence of suspended aliphatic hydrocarbon wax particles that are not incorporated into the core particles, and also can prevent the particle size distribution of the core particles from being broader. Moreover, when a shell layer is formed, it is also possible to reduce a phenomenon in which the core particles become coarser rapidly. Further, the low-temperature fixing is allowed to proceed. By using the first wax with the second wax, it is possible to achieve the high-temperature offset resistance and the separability of paper, to prevent an increase in the particle size, and to produce the core particles having a small particle size and a narrow particle size distribution.

Examples of the alcohol components include methyl, ethyl, propyl, or butyl monoalcohol, glycols such as ethylene glycol or propylene glycol or polymers thereof, triols such as glycerin or polymers thereof, polyalcohols such as pentaerythritol, sorbitan, and cholesterol. When these alcohol components are polyalcohols, the higher fatty acid may be either monosubstituted or polysubstituted.

Specific examples include the following: (i) esters composed of a higher alcohol having a carbon number of 16 to 24 and a higher fatty acid having a carbon number of 16 to 24 such as stearyl stearate, palmityl palmitate, behenyl behenate or stearyl montanate; (ii) esters composed of a higher fatty acid having a carbon number of 16 to 24 and a lower monoalcohol such as butyl stearate, isobutyl behenate, propyl montanate or 2-ethylhexyl oleate; U) esters composed of a higher fatty acid having a carbon number of 16 to 24 and polyalcohol such as a montanic acid monoethylene glycol ester, ethylene glycol distearate, glyceride monostearate, glyceride monobehenate, glyceride tripalmitate, pentaerythritol monobehenate, pentaerythritol dilinoleate, pentaerythritol trioleate or pentaerythritol tetrastearate; and (v) esters composed of a higher fatty acid having a carbon number of 16 to 24 and a polyalcohol polymer such as diethylene glycol monobehenate, diethylene glycol dibehenate, dipropylene glycol monostearate, diglyceride distearate, triglyceride tetrastearate, tetraglyceride hexabehenate or decaglyceride decastearate. These waxes can be used individually or in combinations of two or more.

If the carbon number of the alcohol component and/or the acid component is less than 16, the wax is not likely to function as a dispersion assistant. If it is more than 24, the wax is not likely to function as a low-temperature fixing assistant.

A preferred example of the first wax may include a wax having an iodine value of not more than 25 and a saponification value of 30 to 300. By using the first wax with the second wax, an increase in the particle size can be prevented, thus producing the core particles having a small particle size and a narrow particle size distribution. When the iodine value is defined, the dispersion stability of the wax can be improved, and the wax, resin, and colorant particles can be formed uniformly into core particles, so that the core particles can have a small particle size and a narrow particle size distribution. The first wax preferably has an iodine value of not more than 20 and a saponification value of 30 to 200, and more preferably an iodine value of not more than 10 and a saponification value of 30 to 150.

However, if the iodine value is more than 25, the dispersion stability is too high, and the wax, resin, and colorant particles cannot be formed uniformly into core particles. Thus, the numbers of suspended particles of the wax are likely to be increased, the particles become coarser, and the particle size distribution tends to be broader. The suspended particles may remain in the toner and cause filming of the toner on a photoconductive member or the like. Therefore, the repulsion due to the charging action of the toner cannot be relieved easily during multilayer transfer in the primary transfer process. If the saponification value is less than 30, the presence of unsaponifiable matter and hydrocarbon is increased and makes it difficult to form small uniform core particles. This may result in filming of the toner on a photoconductive member, low chargeability of the toner, and a reduction in chargeability during continuous use. If the saponification value is more than 300, the number of suspended solids in the aqueous medium is increased significantly. The repulsion due to the charging action of the toner cannot be relieved easily. Moreover, fog or toner scattering may be increased.

The wax with a predetermined iodine value and a predetermined saponification value preferably has a heating loss of not more than 8 wt % at 220° C. If the heating loss is more than 8 wt %, the glass transition point of the toner becomes low, and the storage stability is degraded. Moreover, the development property can be affected adversely, and fog or filming of the toner on a photoconductive member is likely to occur. The particle size distribution of the toner becomes broader.

In the molecular weight characteristics of the wax with a predetermined iodine value and a predetermined saponification value, by gel permeation chromatography (GPC), it is preferable that the number-average molecular weight is 100 to 5000, the weight-average molecular weight is 200 to 10000, the ratio (weight-average molecular weight/number-average molecular weight) of the weight-average molecular weight to the number-average molecular weight is 1.01 to 8, the ratio (Z-average molecular weight/number-average molecular weight) of the Z-average molecular weight to the number-average molecular weight is 1.02 to 10, and there is at least one molecular weight maximum peak in the range of 5×10² to 1×10⁴. It is more preferable that the number-average molecular weight is 500 to 4500, the weight-average molecular weight is 600 to 9000, the weight-average molecular weight/number-average molecular weight ratio is 1.01 to 7, and the Z-average molecular weight/number-average molecular weight ratio is 1.02 to 9. It is further preferable that the number-average molecular weight is 700 to 4000, the weight-average molecular weight is 800 to 8000, the weight-average molecular weight/number-average molecular weight ratio is 1.01 to 6, and the Z-average molecular weight/number-average molecular weight ratio is 1.02 to 8.

If the number-average molecular weight is less than 100, the weight-average molecular weight is less than 200, or the molecular weight maximum peak is in the range smaller than 5×10², the storage stability is degraded. Moreover, the handling property of the toner in a developing unit is reduced and thus impairs the uniformity of the toner concentration. The filming of the toner on a photoconductive member may occur. The particle size distribution of the toner tends to be broader.

If the number-average molecular weight is more than 5000, the weight-average molecular weight is more than 10000, the weight-average molecular weight/number-average molecular weight ratio is more than 8, the Z-average molecular weight/number-average molecular weight ratio is more than 10, and the molecular weight maximum peak is in the range larger than 1×10⁴, the releasing action is weakened, and the low-temperature fixability is degraded. Moreover, it is difficult to reduce the particle size of the emulsified and dispersed particles of the wax.

Suitable materials for the first wax may be, e.g., meadowfoam oil, carnauba wax, jojoba oil, Japan wax, beeswax, ozocerite, candelilla wax, ceresin wax, and rice wax, and derivatives of these materials also are preferred. They can be used individually or in combinations of two or more.

Examples of the meadowfoam oil derivative include a meadowfoam oil fatty acid, a metal salt of the meadowfoam oil fatty acid, a meadowfoam oil fatty acid ester, hydrogenated meadowfoam oil, and meadowfoam oil triester. Using these materials can produce an emulsified dispersion having a small particle size and a uniform particle size distribution. Moreover, the materials are effective to improve the low-temperature fixability in the oilless fixing, the life of a developer, and the transfer property. They can be used individually or in combinations of two or more.

The meadowfoam oil fatty acid obtained by saponifying meadowfoam oil preferably includes a fatty acid having 4 to 30 carbon atoms. As a metal salt of the meadowfoam oil fatty acid, e.g., salts of metals such as sodium, potassium, calcium, magnesium, barium, zinc, lead, manganese, iron, nickel, cobalt, and aluminum can be used. With these materials, the high-temperature offset resistance can be improved.

Examples of the meadowfoam oil fatty acid ester include a methyl ester, an ethyl ester, and a butyl ester of the meadowfoam oil fatty acid, and esters of the meadowfoam oil fatty acid and glycerin, pentaerythritol, polypropylene glycol, and trimethylol propane. In particular, e.g., meadowfoam oil fatty acid pentaerythritol monoester, meadowfoam oil fatty acid pentaerythritol triester, or meadowfoam oil fatty acid trimethylol propane ester is preferred. These materials are effective for the low-temperature fixability.

The hydrogenated meadowfoam oil can be obtained by adding hydrogen to the meadowfoam oil to convert unsaturated bonds to saturated bonds. This material can improve the low-temperature fixability and the glossiness.

Moreover, an isocyanate polymer of a meadowfoam oil fatty acid polyol ester, which is obtained by cross-linking a product of the esterification reaction between the meadowfoam oil fatty acid and polyalcohol (e.g., glycerin, pentaerythritol, or trimethylol propane) with isocyanate such as tolylene diisocyanate (TDI) or diphenylmetane-4,4′-diisocyanate (MDI), can be used preferably. This material can suppress toner spent on the carrier, so that the life of a two-component developer can be made even longer.

As the jojoba oil derivative, e.g., a jojoba oil fatty acid, a metal salt of the jojoba oil fatty acid, a jojoba oil fatty acid ester, hydrogenated jojoba oil, jojoba oil triester, a maleic acid derivative of epoxidized jojoba oil, an isocyanate polymer of a jojoba oil fatty acid polyol ester, or halogenated modified jojoba oil also can be used preferably. Using these materials can produce an emulsified dispersion having a small particle size and a uniform particle size distribution. The resin and the wax can be mixed and dispersed uniformly. Moreover, the materials are effective to improve the low-temperature fixability in the oilless fixing, the life of a developer, and the transfer property. They can be used individually or in combinations of two or more.

The jojoba oil fatty acid obtained by saponifying jojoba oil preferably includes a fatty acid having 4 to 30 carbon atoms. As a metal salt of the jojoba oil fatty acid, e.g., salts of metals such as sodium, potassium, calcium, magnesium, barium, zinc, lead, manganese, iron, nickel, cobalt, and aluminum can be used. With these materials, the high-temperature offset resistance can be improved.

Examples of the jojoba oil fatty acid ester include a methyl ester, an ethyl ester, and a butyl ester of the jojoba oil fatty acid, and esters of the jojoba oil fatty acid and glycerin, pentaerythritol, polypropylene glycol, and trimethylol propane. In particular, e.g., jojoba oil fatty acid pentaerythritol monoester, jojoba oil fatty acid pentaerythritol triester, or jojoba oil fatty acid trimethylol propane ester is preferred. These materials are effective for the low-temperature fixability.

The hydrogenated jojoba oil can be obtained by adding hydrogen to the jojoba oil to convert unsaturated bonds to saturated bonds. This material can improve the low-temperature fixability and the glossiness.

Moreover, an isocyanate polymer of a jojoba oil fatty acid polyol ester, which is obtained by cross-linking a product of the esterification reaction between the jojoba oil fatty acid and polyalcohol (e.g., glycerin, pentaerythritol, or trimethylol propane) with isocyanate such as tolylene diisocyanate (TDI) or diphenylmetane-4,4′-diisocyanate (MDI), can be used preferably. This material can suppress toner spent on the carrier, so that the life of a two-component developer can be made even longer.

The saponification value is the milligrams of potassium hydroxide (KOH) required to saponify a 1 g sample and corresponds to the sum of an acid value and an ester value. When the saponification value is measured, a sample is saponified with approximately 0.5N potassium hydroxide in an alcohol solution, and then excess potassium hydroxide is titrated with 0.5N hydrochloric acid.

The iodine value may be determined in the following manner. The amount of halogen absorbed by a sample is measured while the halogen acts on the sample. Then, the amount of halogen absorbed is converted to iodine and expressed in grams per 100 g of the sample. The iodine value is grams of iodine absorbed, and the degree of unsaturation of a fatty acid in the sample increases as the iodine value becomes larger. A chloroform or carbon tetrachloride solution of a sample is prepared, and an alcohol solution of iodine and mercuric chloride or a glacial acetic acid solution of iodine chloride is added to the sample solution. After the mixture is allowed to stand, the iodine that remains without undergoing any reaction is titrated with a sodium thiosulfate standard solution, thus calculating the amount of iodine absorbed.

The heating loss may be measured in the following manner. A sample cell is weighed precisely to the first decimal place (W1 mg). Then, 10 to 15 mg of sample is placed in the sample cell and weighed precisely to the first decimal place (W2 mg). This sample cell is set in a differential thermal balance and measured with a weighing sensitivity of 5 mg. After measurement, the weight loss (W3 mg) of the sample at 220° C. is read to the first decimal place using a chart. The measuring device is, e.g., TGD-3000 (manufactured by ULVAC-RICO, Inc.), the rate of temperature rise is 10° C./min, the maximum temperature is 220° C., and the retention time is 1 min. Accordingly, the heating loss can be determined by the following equation.

Heating loss (%)=W3/(W2−W1)×100

The endothermic peak temperature (melting point ° C.), the onset temperature, and the endotherm of the wax by the DSC method and the MDSC method were measured using a Q100-type differential scanning calorimeter (in which a refrigerated cooling system is used as a cooling device) manufactured by TA Instruments. The measurement mode was set to “standard”, and the flow rate of a purge gas (N₂) was set to 50 ml/min. After the power was turned on, a measurement cell was set at 30° C. and allowed to stand as it was for 1 hour. Then, 8 mg±2 mg of a sample to be measured was put in a crimped aluminum pan. The crimped aluminum pan containing the sample was placed in the measuring equipment. Subsequently, the sample was held at 5° C. for 5 minutes and heated to 120° C. at a heating rate of 1° C./min. The analysis is conducted using “Universal Analysis Version 4.0” included with the device.

In the graphs, the horizontal axis indicates the temperature of an empty crimped aluminum pan used as the reference, and the vertical axis indicates the heat flow expressed by the formula 1 in the measurement with the DSC method and the reverse heat flow expressed by the formula 2 in the measurement with the MDSC method. The temperature at which an endothermic curve starts to rise from the baseline is identified as the onset temperature, and the peak value of the endothermic curve is identified as the endothermic peak temperature (i.e., the melting point).

Under the measurement conditions of the DSC method, the heating rate was 1° C./min. In general, for the DSC measurement, the sample is once heated and cooled to remove the thermal history, and then is heated again while the endotherm is measured. However, it was expected that the structure of the sample would be changed by melting. Therefore, the heating and cooling processes for removal of the thermal history were omitted.

Under the measurement conditions of the MDSC method, the average heating rate was 1° C./min, the modulation period was 40 seconds, and the temperature modulation amplitude was 0.106° C. In this case, the heating rate was changed periodically from a minimum of 0° C./min to a maximum of 2° C./min.

When the endothermic region of the first wax overlapped with that of the second wax, the endotherms of the first and second waxes were calculated by using as a boundary the temperature at which the DSC endothermic curve had a minimum value between the endothermic peak temperature (melting point Tmw1 (° C.)) of the first wax and the endothermic peak temperature (melting point Tmw2 (° C.)) of the second wax.

Preferred materials that can be used together or instead of the above wax as the first wax may be, e.g., a derivative of hydroxystearic acid, a glycerin fatty acid ester, a glycol fatty acid ester, or a sorbitan fatty acid ester. They can be used individually or in combinations of two or more. These materials can produce small core particles that are emulsified and dispersed uniformly. By using the first wax with the second wax, an increase in the particle size can be prevented, thus producing the core particles having a small particle size and a narrow particle size distribution.

Examples of the derivative of hydroxystearic acid include methyl 12-hydroxystearate, butyl 12-hydroxystearate, propylene glycol mono 12-hydroxystearate, glycerin mono 12-hydroxystearate, and ethylene glycol mono12-hydroxystearate. These materials have the effects of improving the low-temperature fixability and the separability of paper in the oilless fixing and preventing filming of the toner on a photoconductive member.

Examples of the glycerin fatty acid ester include glycerol stearate, glycerol distearate, glycerol tristearate, glycerol monopalmitate, glycerol dipalmitate, glycerol tripalmitate, glycerol behenate, glycerol dibehenate, glycerol tribehenate, glycerol monomyristate, glycerol dimyristate, and glycerol trimyristate. These materials have the effects of relieving cold offset at low temperatures in the oilless fixing and preventing a reduction in the transfer property.

Examples of the glycol fatty acid ester include a propylene glycol fatty acid ester such as propylene glycol monopalmitate or propylene glycol monostearate and an ethylene glycol fatty acid ester such as ethylene glycol monostearate or ethylene glycol monopalmitate. These materials have the effects of improving the low-temperature fixability and preventing toner spent on the carrier while increasing the sliding property in development. Examples of the sorbitan fatty acid ester include sorbitan monopalmitate, sorbitan monostearate, sorbitan tripalmitate, and sorbitan tristearate. Moreover, a stearic acid ester of pentaerythritol, mixed esters of adipic acid and stearic acid or oleic acid, and the like are preferred. They can be used individually or in combinations of two or more. These materials have the effects of improving the separability of paper in the oilless fixing and preventing filming of the toner on a photoconductive member.

Preferred examples of the second wax include fatty acid hydrocarbon waxes such as a polypropylene wax, polyethylene wax, polypropylene-polyethylene copolymer wax, microcrystalline wax, paraffin wax, and Fischer-Tropsch wax.

The wax should be incorporated uniformly into the resin so as not to be liberated or suspended during mixing and aggregation. This may be affected by the particle size distribution, composition, and melting property of the wax.

The wax particle dispersion may be prepared in such a manner that the wax in an ion-exchanged water in an aqueous medium including the surface-active agent is heated, melted, and dispersed.

In this case, the wax may be emulsified and dispersed so that the particle size ranges from 20 to 200 nm for 16% diameter (PR16), 40 to 300 nm for 50% diameter (PR50), and is not more than 400 nm for 84% diameter (PR84), and PR84/PR16 is 1.2 to 2.0 in a cumulative volume particle size distribution cumulated from the smaller particle diameter side. It is preferable that the ratio of particles having a diameter not greater than 200 nm is 65 vol % or more, and the ratio of particles having a diameter greater than 500 nm is 10 vol % or less.

Preferably, the particle size may be 20 to 100 nm for 16% diameter (PR16), 40 to 160 nm for 50% diameter (PR50), and not more than 260 nm for 84% diameter (PR84), and PR84/PR16 is 1.2 to 1.8 in the cumulative volume particle size distribution cumulated from the smaller particle diameter side. It is preferable that the ratio of particles having a diameter not greater than 150 nm is 65 vol % or more, and the ratio of particles having a diameter greater than 400 nm is 10 vol % or less.

More preferably, the particle size may be 20 to 60 nm for 16% diameter (PR16), 40 to 120 nm for 50% diameter (PR50), and not more than 220 nm for 84% diameter (PR84), and PR84/PR16 is 1.2 to 1.8 in the cumulative volume particle size distribution cumulated from the smaller particle diameter side. It is preferable that the ratio of particles having a diameter not greater than 130 nm is 65 vol % or more, and the ratio of particles having a diameter greater than 300 nm is 10 vol % or less.

When the resin particle dispersion, the colorant particle dispersion, and the wax particle dispersion are mixed and aggregated to form core particles, the finely dispersed wax particles with a particle size of 40 to 160 nm for 50% diameter (PR50) can be incorporated easily into the resin particles. Therefore, it is possible to prevent aggregation of the wax particles themselves, to achieve uniform dispersion, and to eliminate the particles that are incorporated into the resin particles and suspended in the aqueous medium.

Moreover, when the core particles are heated and melted in the aqueous medium, the molten wax particles are surrounded by the molten resin particles due to surface tension, so that the release agent can be incorporated easily into the resin.

If the particle size is more than 200 nm for PR16, more than 300 nm for PR50, and more than 400 nm for PR84, PR84/PR16 is more than 2.0, the ratio of particles having a diameter not greater than 200 nm is less than 65 vol %, or the ratio of particles having a diameter greater than 500 nm is more than 10 vol %, the wax particles are not incorporated easily into the resin particles and thus are prone to aggregation by themselves. Therefore, a large number of particles that are not incorporated into the core particles are likely to be suspended in the aqueous medium. When the core particles are heated and melted in the aqueous medium, the molten wax particles are not surrounded by the molten resin particles, so that the wax cannot be incorporated easily into the resin. Moreover, the amount of wax that is exposed on the surfaces of the toner base particles and liberated therefrom is increased while further resin particles are fused. This may increase filming of the toner on a photoconductive member or spent of the toner on the carrier, reduce the handling property of the toner in a developing unit, and cause a developing memory.

If the particle size is less than 20 nm for PR16 and less than 40 nm for PR50, and PR84/PR16 is less than 1.2, it is difficult to maintain the dispersion state, and reaggregation of the wax particles may occur during the time the wax particle dispersion is allowed to stand, so that the standing stability of the particle size distribution can be degraded. Moreover, the load and heat generation are increased while the particles are dispersed, thus reducing the productivity.

The wax particles can be dispersed finely in the following manner. A wax melt in which the wax is melted at a concentration of not more than 40 wt % is emulsified and dispersed into a medium that includes a dispersing agent and is maintained at temperatures not less than the melting point of the wax by utilizing the effect of a strong shearing force generated when a rotating body rotates at high speed relative to a fixed body with a predetermined gap between them.

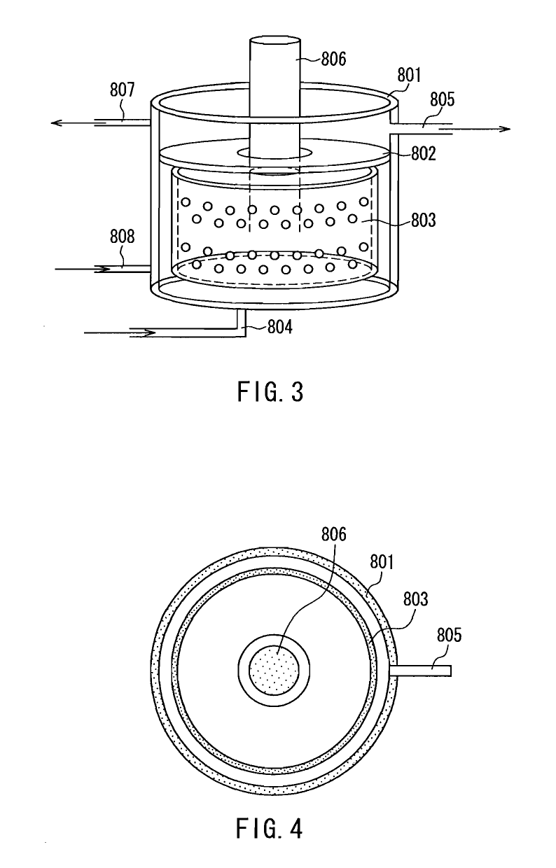

As shown in FIGS. 3 and 4, e.g., a rotating body may be placed in a tank having a certain capacity so that there is a gap of about 0.1 mm to 10 mm between the side of the rotating body and the tank wall. The rotating body rotates at a high speed of not less than 30 m/s, preferably not less than 40 m/s, and more preferably not less than 50 m/s and exerts a strong shearing force on the liquid, thus producing an emulsified dispersion with a finer particle size. A 30-second to 5-minute treatment may be enough to obtain the fine dispersion.

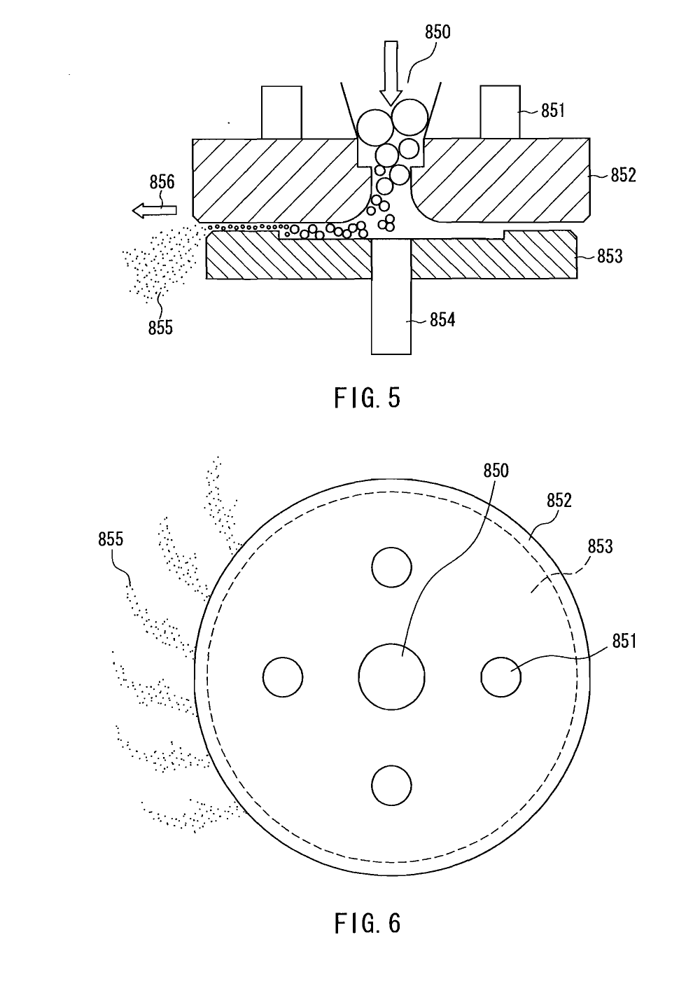

As shown in FIGS. 5 and 6, e.g., a rotor may rotate at a speed of not less than 30 m/s, preferably not less than 40 m/s, and more preferably not less than 50 m/s relative to a stator, while a gap of about 1 to 100 μm is kept between them. This configuration also can provide the effect of a strong shearing force, thus producing a fine dispersion.

In this manner, it is possible to form a narrower and sharper particle size distribution of the fine particles than using a dispersing device such as a homogenizer. It is also possible to maintain a stable dispersion state without causing any reaggregation of the fine particles in the dispersion even when allowed to stand for a long time. Thus, the standing stability of the particle size distribution can be improved.

When the wax has a high melting point, it may be heated under high pressure to form a melt. Alternatively, the wax may be dissolved in an oil solvent. This solution is blended with a surface-active agent or polyelectrolyte and dispersed in water to make a fine particle dispersion by using either of the dispersing devices as shown in FIGS. 3 and 4 and FIGS. 5 and 6, and then the oil solvent is evaporated by heating or under reduced pressure.

The particle size can be measured, e.g., by using a laser diffraction particle size analyzer LA920 (manufactured by Horiba, Ltd.) or SALD2100 (manufactured by Shimadzu Corporation).

(3) Resin

As the resin particles of the toner of this embodiment, e.g., a thermoplastic binder resin can be used. Specific examples of the thermoplastic binder resin include the following: styrenes such as styrene, parachloro styrene, and α-methyl styrene; acrylic monomers such as methyl acrylate, ethyl acrylate, n-propyl acrylate, lauryl acrylate, and 2-ethylhexyl acrylate; methacrylic monomers such as methyl methacrylate, ethyl methacrylate, n-propyl methacrylate, lauryl methacrylate, and 2-ethylhexyl methacrylate; a homopolymer of unsaturated polycarboxylic acid monomers having a carboxyl group as a dissociation group such as acrylic acid, methacrylic acid, maleic acid, or fumaric acid; a copolymer of two or more types of these monomers; or a mixture of these substances.

Examples of a polymerization initiator include azo- or diazo-based initiators such as 2,2′-azobis-(2,4-dimethylvaleronitride), 2,2′-azobisisobutyronitrile, 1,1′-azobis(cyclohexane-1-carbonitrile), 2,2′-azobis-4-methoxy-2,4-direthylvaleronitrile, and azobisisobutyronitrile, persulfates (a potassium persulfate, an ammonium persulfate, etc.), azo compounds (4,4′-azobis-4-cyanovaleric acid and its salt, 2,2′-azobis(2-amidinopropane) and its salt, etc.), and peroxide compounds.

The content of the resin particles in the resin particle dispersion is generally 5 to 50 wt %, and preferably 10 to 40 wt %.

To produce the core particles having a sharp particle size distribution by the aggregation reaction with the wax particles and the colorant particles while eliminating the presence of suspended particles, the first resin particles preferably have a glass transition point of 45° C. to 60° C. and a softening point of 90° C. to 140° C., more preferably a glass transition point of 45° C. to 55° C. and a softening point of 90° C. to 135° C., and further preferably a glass transition point of 45° C. to 52° C. and a softening point of 90° C. to 130° C.

As a preferred configuration of the first resin particles, the weight-average molecular weight (Mw) is 10000 to 60000, and the ratio (Mw/Mn) of the weight-average molecular weight (Mw) to the number-average molecular weight M) is 1.5 to 6. It is more preferable that the weight-average molecular weight (Mw) is 10000 to 50000, and the ratio (Mw/Mn) of the weight-average molecular weight (Mw) to the number-average molecular weight M) is 1.5 to 3.9. It is further preferable that the weight-average molecular weight GMw) is 10000 to 30000, and the ratio (Mw/Mn) of the weight-average molecular weight (Mw) to the number-average molecular weight (Mn) is 1.5 to 3.

With this configuration, the dispersibility of the molten resin particles and the first wax is improved during the aggregation reaction, so that the core particles can be prevented from being coarser and can be produced efficiently with a narrow particle size distribution. The values of Jmw1/Jw1 and Jmw2/Jw2 can be controlled within the predetermined numerical ranges, respectively. It is also possible to ensure the low-temperature fixability, to reduce a change in image glossiness with respect to the fixing temperature, and to make the image glossiness constant. Since the image glossiness generally increases with the fixing temperature, the glossiness of an image varies depending on the fixing temperature. Therefore, the fixing temperature has to be controlled strictly. However, the above configuration is effective to reduce variations in the image glossiness, even if the fixing temperature changes.

If the glass transition point of the first resin particles is lower than 45° C., the core particles become coarser, and the storage stability and the heat resistance are reduced. If the glass transition point is higher than 60° C., the low-temperature fixability is degraded. If Mw is smaller than 10000, the core particles become coarser, and the storage stability and the heat resistance are reduced. If Mw is larger than 60000, the low-temperature fixability is degraded. If Mw/Mn is larger than 6, the core particles are not stable but irregular in shape, have uneven surfaces, and thus may result in poor surface smoothness.

Moreover, it is preferable that the second resin particles are fused with the individual core particles to form a resin fused layer. As a preferred configuration of the second resin particles, the glass transition point is 55° C. to 75° C., the softening point is 140° C. to 180° C., the weight-average molecular weight (Mw) is 50000 to 500000, and the ratio (Mw/Mn) of the weight-average molecular weight (Mw) to the number-average molecular weight (Mn) is 2 to 10, measured by gel permeation chromatography (GPC). It is more preferable that the glass transition point is 60° C. to 70° C., the softening point is 145° C. to 180° C., Mw is 80000 to 500000, and Mw/Mn is 2 to 7. It is further preferable that the glass transition point is 65° C. to 70° C., the softening point is 150° C. to 180° C., Mw is 120000 to 500000, and Mw/Mn is 2 to 5.

With this configuration, the thermal adhesiveness of the second resin particles to the surface of the individual core particles is promoted, and the softening point is set to be higher, thereby improving the durability, high-temperature offset resistance, and separability. If the glass transition point of the second resin particles is lower than 55° C., secondary aggregation is likely to occur, and the storage stability is degraded. If it is higher than 75° C., the thermal adhesiveness is degraded, and the uniform adhesion of the second resin particles is reduced. If the softening point of the second resin particles is lower than 140° C., the durability, the high-temperature offset resistance, and the separability are reduced. If it is higher than 180° C., the glossiness and the transmittance are reduced. The molecular weight distribution is brought closer to a monodisperse state by decreasing Mw/Mn of the second resin particles, so that the second resin particles can be fused uniformly with the surface of the individual core particles. If Mw of the second resin particles is smaller than 50000, the durability, the high-temperature offset resistance, and the separability of paper are reduced. If it is larger than 500000, the low-temperature fixability, the glossiness, and the transmittance are reduced.

The first resin particles are preferably 60 wt % or more, more preferably 70 wt % or more, and further preferably 80 wt % or more of the total resin of the toner.

The molecular weights of the resin, wax, and toner can be measured by gel permeation chromatography (GPC) using several types of monodisperse polystyrene as standard samples.

The measurement may be performed with HLC 8120 GPC series manufactured by TOSOH CORP., using TSK gel super HM-H H4000/H3000/H2000 (6.0 mm I.D.-150 mm×3) as a column and THF (tetrahydrofuran) as an eluent, at a flow rate of 0.6 mL/min, a sample concentration of 0.1%, an injection amount of 20 μL, RI as a detector, and at a temperature of 40° C. Prior to the measurement, the sample is dissolved in THF and allowed to stand overnight, and then is filtered through a 0.45 μm membrane filter so that additives such as silica are removed, to measure the resin component. The measurement requirement is that the molecular weight distribution of the subject sample is in the range where the logarithms and the count numbers of the molecular weights in the analytical curve obtained from the several types of monodisperse polystyrene standard samples form a straight line.

The softening point of the binder resin can be measured by a capillary rheometer flow tester (CFT-500, constant-pressure extrusion system, manufactured by Shimadzu Corporation). A load of about 9.8×10⁵ N/m² is applied to a 1 cm³ sample with a plunger while heating the sample at a rate of temperature rise of 6° C./min, so that the sample is extruded from a die having a diameter of 1 mm and a length of 1 mm. By the relationship between the piston stroke of the plunger and the temperature increase characteristics, when the temperature at which the piston stroke starts to occur is a flow start temperature (Tfb), one-half the difference between the minimum value of a curve of the piston stroke characteristics and the flow end point is determined. Then, the resultant value and the minimum value of the curve are added to define a point, and the temperature of this point is identified as a melting point (softening point Ts° C.) according to a ½ method.

The glass transition point of the resin can be measured by a differential scanning calorimeter (DSC-50 manufactured by Shimadzu Corporation). The temperature of a sample is raised to 100° C., retained for 3 minutes, and reduced to room temperature at 10° C./min. Subsequently, the temperature is raised at 10° C./min, and a thermal history of the sample is measured. In the thermal history, an intersection point of an extension line of the baseline lower than a glass transition point and a tangent that shows the maximum inclination between the rising point and the highest point of a peak is determined. The temperature of this intersection point is identified as a glass transition point.

(4) Pigment

Carbon black is used as a black pigment of the colorant (pigment) in this embodiment. As described above, the DBP (dibutyl phthalate) oil absorption (ml/100 g) of carbon black is 45 to 70. The particle size of the black pigment is preferably 20 to 40 nm, and more preferably 20 to 35 nm. In this case, the particle size is an arithmetic average particle size measured by an electron microscope. If the particle size is too large, the coloring power is reduced. If the particle size is too small, the dispersion of the black pigment in the liquid becomes difficult. For example, preferred materials are #52 (particle size: 27 nm, DBP oil absorption: 63 ml/100 g), #50 (particle size: 28 nm, DBP oil absorption: 65 ml/100 g), #47 (particle size: 23 nm, DBP oil absorption: 64 ml/100 g), #45 (particle size: 24 nm, DBP oil absorption: 53 ml/100 g), and #45L (particle size: 24 nm, DBP oil absorption: 45 ml/100 g) that are manufactured by Mitsubishi Chemical Corporation, and REGAL 250R (particle size: 35 nm, DBP oil absorption: 46 ml/100 g), REGAL 330R (particle size: 25 nm, DBP oil absorption: 65 ml/100 g), and MOGULL (particle size: 24 nm, DBP oil absorption: 60 ml/100 g) that are manufactured by Cabot Corporation. Among them, more preferred materials are #45, #45L, and REGAL 250R.

The DBP oil absorption is measured in accordance with JIS K6217. Specifically, 20 g of a sample (A) is dried at 150° C.±1° C. for 1 hour, and then is put into a mixing chamber of an “Absorptometer” (with a spring tension of 2.68 kg/cm, manufactured by Brabender Inc.). After the limit switch has been set to about 70% of the maximum torque, a mixing machine is rotated. At the same time, DBP (specific gravity: 1.045 to 1.050 g/cm³) is added at a rate of 4 ml/min from an automatic buret. When it is close to the end point, the torque increases rapidly, and the limit switch is turned off. By the amount of DBP added (B ml) to that point and the weight of the sample, the DBP oil absorption per 100 g of the sample (=B×100/A) (ml/100 g) is determined.

Examples of the pigments to be used as color toners include the following. As a yellow pigment, acetoacetic acid aryl amide monoazo yellow pigments such as C. I. Pigment Yellow 1, 3, 74, 97 and 98, acetoacetic acid aryl amide disazo yellow pigments such as C. I. Pigment Yellow 12, 13, 14 and 17, C. I. Solvent Yellow 19, 77 and 79, or C. I. Disperse Yellow 164 can be used. In particular, benzimidazolone pigments of C. I. Pigment Yellow 93, 180 and 185 are preferred.

As a magenta pigment, red pigments such as C. I. Pigment Red 48, 49:1, 53:1, 57, 57:1, 81, 122 and 5, or red dyes such as C. I. Solvent Red 49, 52, 58 and 8 can be used preferably.

As a cyan pigment, blue dyes/pigments of phthalocyanine and its derivative such as C. I. Pigment Blue 15:3 can be used preferably. The added amount is preferably 3 to 8 parts by weight per 100 parts by weight of the binder resin.

The median diameter of the pigment particles is generally 1 μm or less, and preferably 0.01 to 1 μm. If the median diameter is more than 1 μm, the toner as a final product for electrostatic charge image development can have a broader particle size distribution. Moreover, liberated particles are generated and tend to reduce the performance or reliability. When the median diameter is within the above range, these disadvantages are eliminated, and the uneven distribution of the toner is decreased. Therefore, the dispersion of the pigment particles in the toner can be improved, resulting in a smaller variation in performance and reliability. The median diameter can be measured, e.g., by a laser diffraction particle size analyzer (LA 920 manufactured by Horiba, Ltd.).

(5) Additive

In this embodiment, an inorganic fine powder is added as an additive. Examples of the additive include a metal oxide fine powder such as silica, alumina, titanium oxide, zirconia, magnesia, ferrite or magnetite, titanate such as barium titanate, calcium titanate or strontium titanate, zirconate such as barium zirconate, calcium zirconate or strontium zirconate, and a mixture of these substances. The additive can be made hydrophobic as needed.

Examples of silicone oil materials used to treat the additive include dimethyl silicone oil, methyl hydrogen silicone oil, methyl phenyl silicone oil, epoxy modified silicone oil, carboxyl modified silicone oil, methacrylic modified silicone oil, alkyl modified silicone oil, fluorine modified silicone oil, amino modified silicone oil, and chlorophenyl modified silicone oil. The additive that is treated with at least one of the above silicone oil materials is used preferably. For example, SH200, SH510, SF230, SH203, BY16-823, or BY16-855B manufactured by Toray-Dow Corning Co., Ltd can be used. The treatment may be performed by mixing the additive and the silicone oil material with a mixer (e.g., a Henshel mixer, FM20B manufactured by Mitsui Mining Co., Ltd.). Moreover, the silicone oil material may be sprayed onto the additive. Alternatively, the silicone oil material may be dissolved or dispersed in a solvent, and mixed with the additive, followed by removal of the solvent. The amount of the silicone oil material is preferably 1 to 20 parts by weight per 100 parts by weight of the additive.

Examples of a silane coupling agent include dimethyldichlorosilane, trimethylchlorosilane, allyldimethylchlorosilane, hexamethyldisilazane, allylphenyldichlorosilane, vinyltriethoxysilane, divinylchlorosilane, and dimethylvinylchlorosilane. The silane coupling agent may be treated by a dry treatment in which the additive is fluidized by agitation or the like, and an evaporated silane coupling agent is reacted with the fluidized additive, or a wet treatment in which a silane coupling agent dispersed in a solvent is added dropwise to the additive.

It is also preferable that the silicone oil material is treated after a silane coupling treatment.

The additive having positive chargeability may be treated with aminosilane, amino modified silicone oil, or epoxy modified silicone oil.

To enhance a hydrophobic treatment, hexamethyldisilazane, dimethyldichlorosilane, or other silicone oils also can be used along with the above materials. For example, at least one selected from dimethyl silicone oil, methylphenyl silicone oil, and alkyl modified silicone oil is preferred to treat the additive.

It is also preferable that the surface of the additive is treated with one or more selected from a fatty acid ester, fatty acid amide, fatty acid, and fatty acid metal salt (referred to as “fatty acid or the like” in the following). The surface-treated silica or titanium oxide fine powder is more preferred.

Examples of the fatty acid and the fatty acid metal salt include a caprylic acid, capric acid, undecylic acid, lauric acid, myristic acid, palmitic acid, stearic acid, behenic acid, montanic acid, lacceric acid, oleic acid, erucic acid, sorbic acid, and linoleic acid. In particular, the fatty acid having a carbon number of 12 to 22 is preferred.

Metals of the fatty acid metal salt may be, e.g., aluminum, zinc, calcium, magnesium, lithium, sodium, lead, or barium. Among these metals, aluminum, zinc, and sodium are preferred. Further, mono- and di-fatty acid aluminum such as aluminum distearate (Al(OH)(C₁₇H₃₅COO)) or aluminum monostearate (Al(OH)₂(C₁₇H₃₅COO)) are particularly preferred. The presence of a hydroxy group can prevent overcharge and suppress a transfer failure. Moreover, it may be possible to improve the treatment of the additive.

Preferred examples of aliphatic amide include saturated or mono-unsaturated aliphatic amide having a carbon number of 16 to 24 such as palmitic acid amide, palmitoleic acid amide, stearic acid amide, oleic acid amide, arachidic acid amide, eicosanoic acid amide, behenic acid amide, erucic acid amide, or lignoceric acid amide.

Preferred examples of the fatty acid ester include the following: esters composed of a higher alcohol having a carbon number of 16 to 24 and a higher fatty acid having a carbon number of 16 to 24 such as stearyl stearate, palmityl palmitate, behenyl behenate, or stearyl montanate; esters composed of a higher fatty acid having a carbon number of 16 to 24 and a lower monoalcohol such as butyl stearate, isobutyl behenate, propyl montanate, or 2-ethylhexyl oleate; fatty acid pentaerythritol monoester; fatty acid pentaerythritol triester; and fatty acid trimethylol propane ester.

Moreover, materials such as a derivative of hydroxystearic acid and a polyol fatty acid ester such as a glycerin fatty acid ester, glycol fatty acid ester, or sorbitan fatty acid ester are preferred. They can be used individually or in combinations of two or more.

In a preferred surface treatment, the surface of the additive may be treated with a coupling agent and/or polysiloxane such as silicone oil, and subsequently treated with the fatty acid or the like. This is because a more uniform treatment can be performed than when hydrophilic silica merely is treated with a fatty acid, high charging of the toner can be achieved, and the flowability can be improved when the additive is added to the toner. The above effect also can be obtained by treating with the fatty acid or the like along with a coupling agent and/or silicone oil.

The surface treatment may be performed by dissolving the fatty acid or the like in a hydrocarbon organic solvent such as toluene, xylene, or hexane, wet mixing this solution with an additive such as silica, a titanium oxide, or alumina in a dispersing device, and allowing the fatty acid or the like to adhere to the surface of the additive with the treatment agent. After the surface treatment, the solvent is removed, and a drying process is performed.

It is preferable that the mixing ratio of polysiloxane to the fatty acid or the like is 1:2 to 20:1. If the fatty acid or the like is increased to a ratio higher than 1:2, the charge amount of the additive becomes high, the image density is reduced, and charge-up is likely to occur in two-component development. If the fatty acid or the like is decreased to a ratio lower than 20:1, the effect of suppressing transfer voids or reverse transfer is reduced.

In this case, the ignition loss of the additive whose surface has been treated with the fatty acid or the like is preferably 1.5 to 25 wt %, more preferably 5 to 25 wt %, and further preferably 8 to 20 wt %. If the ignition loss is smaller than 1.5 wt %, the treatment agent does not function sufficiently, and the effects of improving the chargeability and the transfer property are not observed. If the ignition loss is larger than 25 wt %, the treatment agent remains unused and may affect the developing property or durability adversely.

Unlike the conventional pulverizing process, the surface of the individual toner base particles produced in the present invention is smooth and uniform, and consists mainly of resin. Therefore, it is advantageous in terms of charge uniformity, but affinity with the additive used for the charge-imparting property or charge-retaining property becomes important.

It is preferable that the additive having an average particle size of 6 nm to 200 nm is added in an amount of 1 to 6 parts by weight per 100 parts by weight of toner base particles. If the average particle size is less than 6 nm, suspended particles are generated, and filming of the toner on a photoconductive member is likely to occur. Therefore, it is difficult to avoid the occurrence of reverse transfer. If the average particle size is more than 200 nm, the flowability of the toner is decreased. If the amount of the additive is less than 1 part by weight, the flowability of the toner is decreased, and it is difficult to avoid the occurrence of reverse transfer. If the amount of the additive is more than 6 parts by weight, suspended particles are generated, and filming of the toner on a photoconductive member is likely to occur, thus degrading the high-temperature offset resistance.

Moreover, it is preferable that at least the additive having an average particle size of 6 nm to 20 nm is added in an amount of 0.5 to 2.5 parts by weight per 100 parts by weight of the toner base particles, and the additive having an average particle size of 20 nm to 200 nm is added in an amount of 0.5 to 3.5 parts by weight per 100 parts by weight of toner base particles. With this configuration, the additives of different functions can improve both the charge-imparting property and the charge-retaining property, and also can ensure larger tolerances against reverse transfer, transfer voids, and scattering of the toner during transfer. In this case, the ignition loss of the additive having an average particle size of 6 nm to 20 nm is preferably 0.5 to 20 wt %, and the ignition loss of the additive having an average particle size of 20 nm to 200 nm is preferably 1.5 to 25 wt %. When the ignition loss of the additive having an average particle size of 20 nm to 200 nm is larger than that of the additive having an average particle size of 6 nm to 20 nm, it is effective in improving the charge-retaining property and suppressing reverse transfer and transfer voids.

By specifying the ignition loss of the additive, larger tolerances can be ensured against reverse transfer, transfer voids, and scattering of the toner during transfer. Moreover, the handling property of the toner in a developing unit can be improved, thus increasing the uniformity of the toner concentration.

If the ignition loss of the additive having an average particle size of 6 nm to 20 nm is less than 0.5 wt %, the tolerances against reverse transfer and transfer voids become narrow. If the ignition loss is more than 20 wt %, the surface treatment is not uniform, resulting in charge variations. The ignition loss is preferably 1.5 to 17 wt %, and more preferably 4 to 10 wt %.

If the ignition loss of the additive having an average particle size of 20 nm to 200 nm is less than 1.5 wt %, the tolerances against reverse transfer and transfer voids become narrow. If the ignition loss is more than 25 wt %, the surface treatment is not uniform, resulting in charge variations. The ignition loss is preferably 2.5 to 20 wt %, and more preferably 5 to 15 wt %.

Further, it is preferable that at least the additive having an average particle size of 6 nm to 20 nm and an ignition loss of 0.5 to 20 wt % is added in an amount of 0.5 to 2 parts by weight per 100 parts by weight of the toner base particles, the additive having an average particle size of 20 nm to 100 nm and an ignition loss of 1.5 to 25 wt % is added in an amount of 0.5 to 3.5 parts by weight per 100 parts by weight of the toner base particles, and the additive having an average particle size of 100 nm to 200 nm and an ignition loss of 0.1 to 10 wt % is added in an amount of 0.5 to 2.5 parts by weight per 100 parts by weight of toner base particles. With this configuration, the additives of different functions, each having the specified average particle size and ignition loss, are effective in improving both the charge-imparting property and the charge-retaining property, suppressing reverse transfer and transfer voids, and removing substances attached to the surface of a carrier.

It is also preferable that a positively charged additive having an average particle size of 6 nm to 200 nm and an ignition loss of 0.5 to 25 wt % is added further in an amount of 0.2 to 1.5 parts by weight per 100 parts by weight of toner base particles.

The addition of the positively charged additive can suppress the overcharge of the toner for a long period of continuous use and increase the life of a developer. Therefore, the scattering of the toner during transfer caused by overcharge also can be reduced. Moreover, it is possible to prevent toner spent on the carrier. If the amount of positively charged additive is less than 0.2 parts by weight, these effects are not likely to be obtained. If it is more than 1.5 parts by weight, fog is increased significantly during development. The ignition loss is preferably 1.5 to 20 wt %, and more preferably 5 to 19 wt %.

A drying loss (%) may be determined in the following manner. A container is dried, allowed to stand and cool, and weighed precisely beforehand. Then, a sample (about 1 g) is put in the container, weighed precisely, and dried for 2 hours with a hot-air dryer at 105° C.±1° C. After cooling for 30 minutes in a desiccator, the weight is measured, and the drying loss is calculated by the following formula.

Drying loss (wt %)=[weight loss (g) by drying/sample amount (g)]×100

An ignition loss may be determined in the following manner. A magnetic crucible is dried, allowed to stand and cool, and weighed precisely beforehand. Then, a sample (about 1 g) is put in the crucible, weighed precisely, and ignited for 2 hours in an electric furnace at 500° C. After cooling for 1 hour in a desiccator, the weight is measured, and the ignition loss is calculated by the following formula.

Ignition loss (wt %)=[weight loss (g) by ignition/sample amount (g)]×100

The amount of moisture absorption of the surface-treated additive may be 1 wt % or less, preferably 0.5 wt % or less, more preferably 0.1 wt % or less, and further preferably 0.05 wt % or less. If the amount is more than 1 wt %, the chargeability is degraded, and filming of the toner on a photoconductive member occurs over time. The amount of moisture absorption can be measured by a continuous vapor absorption measuring device (BELSORP 18 manufactured by BEL JAPAN, INC.).

The degree of hydrophobicity may be determined in the following manner. A sample (0.2 g) is weighed out and added to 50 ml of distilled water placed in a 250 ml beaker. Then, methanol is added dropwise from a buret, whose end is put into the liquid, until the entire amount of the additive is wetted while continuing the stirring slowly with a magnetic stirrer. By the amount a (ml) of methanol required to wet the additive completely, the degree of hydrophobicity is calculated by the following formula.

Degree of hydrophobicity (%)=(a/(50+a))×100

(6) Powder Physical Characteristics of Toner

In this embodiment, it is preferable that toner base particles including a binder resin, a colorant, and wax have a volume-average particle size of 3 to 7 μm, the content of the toner base particles having a particle size of 2.52 to 4 μm in a number distribution is 10 to 75% by number, the toner base particles having a particle size of 4 to 6.06 μm in a volume distribution is 25 to 75% by volume, the toner base particles having a particle size of not less than 8 μm in the volume distribution is not more than 5% by volume, P46/V46 is in the range of 0.5 to 1.5 where V46 is the volume percentage of the toner base particles having a particle size of 4 to 6.06 μm in the volume distribution and P46 is the number percentage of the toner base particles having a particle size of 4 to 6.06 μm in the number distribution, the coefficient of variation in the volume-average particle size is 10 to 25%, and the coefficient of variation in the number particle size distribution is 10 to 28%.

More preferably, the toner base particles have a volume-average particle size of 3 to 6.5 μm, the content of the toner base particles having a particle size of 2.52 to 4 μm in the number distribution is 20 to 75% by number, the toner base particles having a particle size of 4 to 6.06 μm in the volume distribution is 35 to 75% by volume, the toner base particles having a p article size of not less than 8 μm in the volume distribution is not more than 3% by volume, P46/V46 is in the range of 0.5 to 1.3, the coefficient of variation in the volume-average particle size is 10 to 20%, and the coefficient of variation in the number particle size distribution is 10 to 23%. Further preferably, the toner base particles have a volume-average particle size of 3 to 5 μm, the content of the toner base particles having a particle size of 2.52 to 4 μm in the number distribution is 40 to 75% by number, the toner base particles having a particle size of 4 to 6.06 μm in the volume distribution is 45 to 75% by volume, the toner base particles having a particle size of not less than 8 μm in the volume distribution is not more than 1% by volume, P46/V46 is in the range of 0.5 to 0.9, the coefficient of variation in the volume-average particle size is 10 to 15%, and the coefficient of variation in the number particle size distribution is 10 to 18%.

The toner base particles with the above characteristics can provide high-resolution image quality, prevent reverse transfer and transfer voids during tandem transfer, and achieve the oilless fixing. The fine powder in the toner affects the flowability, image quality, and storage stability of the toner, filming of the toner on a photoconductive member, developing roller, or transfer member, the aging property, the transfer property, and particularly the multilayer transfer property in a tandem system. The fine powder also affects the offset resistance, glossiness, and transmittance in the oilless fixing. When the toner includes wax or the like to achieve the oilless fixing, the amount of fine powder may affect the compatibility between the oilless fixing and the tandem transfer property.

If the volume-average particle size is more than 7 μm, the image quality and the transfer property cannot be ensured together. If the volume-average particle size is less than 3 μm, the handling property of the toner particles in development is reduced.

If the content of the toner base particles having a particle size of 2.52 to 4 μm in the number distribution is less than 10% by number, the image quality and the transfer property cannot be ensured together. If it is more than 75% by number, the handling property of the toner particles in development is reduced. Moreover, the filming of the toner on a photoconductive member, developing roller, or transfer member is likely to occur. The adhesion of the fine powder to a heat roller is large, and thus tends to cause offset. In the tandem system, the agglomeration of the toner is likely to be stronger, which easily leads to a transfer failure of the second color during multilayer transfer.

If the toner base particles having a particle size of 4 to 6.06 μm in the volume distribution is more than 75% by volume, the image quality and the transfer property cannot be ensured together. If it is less than 25% by volume, the image quality is degraded.

If the toner base particles having a particle size of not less than 8 μm in the volume distribution is more than 5% by volume, the image quality is degraded, and a transfer failure may occur.

If P46/V46 is less than 0.5, where V46 is the volume percentage of the toner base particles having a particle size of 4 to 6.06 μm in the volume distribution and P46 is the number percentage of the toner base particles having a particle size of 4 to 6.06 μm in the number distribution, the amount of fine powder is increased excessively, so that the flowability and the transfer property are decreased, and fog becomes worse. If P46/V46 is more than 1.5, the number of large particles is increased, and the particle size distribution becomes broader. Thus, high image quality cannot be achieved.

The purpose of controlling P46/V46 is to provide an index for reducing the size of the toner particles and narrowing the particle size distribution.

The coefficient of variation is obtained by dividing a standard deviation by an average particle size of the toner particles by the measurement using a Coulter Counter (manufactured by Coulter Electronics, Inc.). When the particle sizes of n particles are measured, the standard deviation can be expressed by the square root of the value that is obtained by dividing the square of a difference between each of the n measured values and the mean value by (n−1).

In other words, the coefficient of variation indicates the degree of expansion of the particle size distribution. When the coefficient of variation of the volume particle size distribution or the number particle size distribution is less than 10%, the production becomes difficult, and the cost is increased. When the coefficient of variation of the volume particle size distribution is more than 25%, or when the coefficient of variation of the number particle size distribution is more than 28%, the particle size distribution is broader, and the agglomeration of toner is stronger. This may lead to filming of the toner on a photoconductive member, a transfer failure, and difficulty in recycling the residual toner in a cleanerless process. The particle size distribution is measured, e.g., by using a Coulter Counter TA-II (manufactured by Coulter Electronics, Inc.). An interface (manufactured by Nikkaki Bios Co., Ltd.) and a personal computer for outputting a number distribution and a volume distribution are connected to the Coulter Counter TA-II. An electrolytic solution (about 50 ml) is prepared by including a surface-active agent (sodium lauryl sulfate) so as to have a concentration of 1 wt %. About 2 mg of toner to be measured is added to the electrolytic solution. This electrolytic solution in which the sample is suspended is dispersed for about 3 minutes with an ultrasonic dispersing device, and then is measured using the 70 μm aperture of the Coulter Counter TA-II. In the 70 μm aperture system, the measurement range of the particle size distribution is 1.26 μm to 50.8 μm. However, the region smaller than 2.0 μm is not suitable for practical use because the measurement accuracy or reproducibility is low due to the influence of external noise or the like. Therefore, the measurement range is set from 2.0 em to 50.8 μm.

A compression ratio calculated from a static bulk density and a dynamic bulk density can be used as an index of the flowability of the toner. The toner flowability may be affected by the particle size distribution and particle shape of the toner, and the type or amount of the additive and the wax. When the particle size distribution of the toner is narrow, less fine powder is present, the toner surface is not rough, the toner shape is close to spherical, a large amount of additive is added, and the additive has a small particle size, the compression ratio is reduced, and the toner flowability is increased. The compression ratio is preferably 5 to 40%, and more preferably 10 to 30%. This can ensure the compatibility between the oilless fixing and the multilayer transfer property in the tandem system. If the compression ratio is less than 5%, the fixability is degraded, and particularly the transmittance is likely to be lower. Moreover, toner scattering from the developing roller may be increased. If the compression ratio is more than 40%, the transfer property is decreased to cause a transfer failure such as transfer voids in the tandem system.

(7) Tandem Color Process

This embodiment employs the following transfer process for high-speed color image formation. A plurality of toner image forming stations, each of which includes a photoconductive member, a charging member, and a toner support member, are used. In a primary transfer process, an electrostatic latent image formed on the photoconductive member is made visible by development, and a toner image thus developed is transferred to an endless transfer member that is in contact with the photoconductive member. The primary transfer process is performed continuously in sequence so that a multilayer toner image is formed on the transfer member. Then, a secondary transfer process is performed by collectively transferring the multilayer toner image from the transfer member to a transfer medium such as paper or OHP sheet. The transfer process satisfies the relationship expressed as

d1/v≦0.65

where d1 (mm) is a distance between the first primary transfer position and the second primary transfer position, and v (mm/s) is a circumferential velocity of the photoconductive member. This configuration can reduce the machine size and improve the printing speed. To process at least 20 sheets (A4) per minute and to make the size small enough to be used for SOHO (small office/home office) purposes, a distance between the toner image forming stations should be as short as possible, while the processing speed should be enhanced. Thus, d1/v≦0.65 is considered to be the minimum requirement to achieve both small size and high printing speed.

However, when the distance between the toner image forming stations is too short, e.g., when a period of time from the primary transfer of the first color (yellow toner) to that of the second color (magenta toner) is extremely short, the charge of the transfer member or the charge of the transferred toner hardly is eliminated. Therefore, when the magenta toner is transferred onto the yellow toner, it is repelled by the charging action of the yellow toner. This may lead to lower transfer efficiency and transfer voids. When the third color (cyan toner) is transferred onto the yellow and the magenta toner, the cyan toner may be scattered to cause a transfer failure or considerable transfer voids. Moreover, the toner having a specified particle size is developed selectively with repeated use, and the individual toner particles differ significantly in flowability, so that frictional charge opportunities are different. Thus, the charge amount is varied and the transfer property is reduced further.

In such a case, therefore, the toner or two-component developer of this embodiment can be used to stabilize the charge distribution and suppress the overcharge and flowability variations. Accordingly, it is possible to prevent lower transfer efficiency, transfer voids, and reverse transfer without sacrificing the fixing property.

(8) Oilless Color Fixing

The toner of this embodiment can be used preferably in an electrographic apparatus having a fixing process of oilless fixing that applies no oil to any fixing means. For heating, electromagnetic induction heating is suitable in view of reducing the warm-up time and power consumption. The oilless fixing configuration includes a magnetic field generation means and a heating and pressing means. The heating and pressing means includes a rotational heating member and a rotational pressing member. The rotational heating member includes at least a heat generation layer for generating heat by electromagnetic induction and a release layer. There is a certain nip between the rotational heating member and the rotational pressing member. The toner that has been transferred to a transfer medium such as copy paper is fixed by passing the transfer medium between the rotational heating member and the rotational pressing member. This configuration is characterized by the warm-up time of the rotational heating member that has a quick rising property as compared with a conventional configuration using a halogen lamp. Therefore, the copying operation starts before the temperature of the rotational pressing member is raised sufficiently. Thus, the toner is required to have the low-temperature fixability and a wide range of the offset resistance.

Another configuration in which a heating member is separated from a fixing member and a fixing belt runs between the two members also can be used preferably. The fixing belt may be, e.g., a nickel electroformed belt having heat resistance and deformability or a heat-resistant polyimide belt. Silicone rubber, fluorocarbon rubber, or fluorocarbon resin may be used as a surface coating to improve the releasability.

In the conventional fixing process, release oil has been applied to prevent offset. The toner that exhibits releasability without using oil can eliminate the need for application of the release oil. However, if the release oil is not applied to the fixing means, it can be charged easily. Therefore, when an unfixed toner image is close to the heating member or the fixing member, the toner may be scattered due to the influence of charge. Such scattering is likely to occur, particularly at low temperature and low humidity.

In contrast, the toner of this embodiment can achieve the low-temperature fixability and a wide range of the offset resistance without using oil. The toner also can provide high color transmittance. Thus, the use of the toner of this embodiment can suppress overcharge as well as scattering caused by the charging action of the heating member or the fixing member.

### EXAMPLES

### (1) Carrier Producing Example

MnO (39.7 mol %), MgO (9.9 mol %), Fe₂O₃ (49.6 mol %), and SrO (0.8 mol %) were placed in a wet ball mill, and then were pulverized and mixed for 10 hours. The resultant mixture was dried, kept at 950° C. for 4 hours, and pre-calcined. This was pulverized for 24 hours in a wet ball mill, and then was granulated and dried by a spray dryer. The granulated substance was kept in an electric furnace at 1270° C. for 6 hours in an atmosphere having an oxygen concentration of 2%, and calcined. The fired substance was ground and further classified, thus producing a core material of ferrite particles that had an average particle size of 50 μm and a saturation magnetization of 65 emu/g in an applied magnetic field of 3000 oersteds.

Next, 250 g of polyorganosiloxane expressed as the following Chemical Formula (1) in which R¹ and R² are a methyl group, i.e., (CH₃)₂SiO_{2/2} unit is 15.4 mol % and the following Chemical Formula (2) in which R³ is a methyl group, i.e., CH₃SiO_{3/2} unit is 84.6 mol % was allowed to react with 21 g of CF₃CH₂CH₂Si(OCH₃)₃ to produce a fluorine modified silicone resin. Then, 100 g of the fluorine modified silicone resin (as represented in terms of solid constituents) and 10 g of aminosilane coupling agent (γ-aminopropyltriethoxysilane) were weighed out and dissolved in 300 cc of toluene solvent.

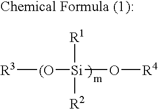

(where R¹, R², R³, and R⁴ are a methyl group, and m represents a mean degree of polymerization of 100)

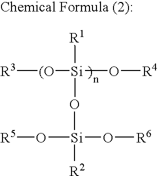

(where R¹, R², R³, R⁴, R⁵, and R⁶ are a methyl group, and n represents a mean degree of polymerization of 80)

Using a dip and dry coater, 10 kg of the ferrite particles were coated by stirring the resin coating solution for 20 minutes, and then were baked at 260° C. for 1 hour, providing a carrier CA1.

### (2) Resin Particle Dispersion Production

Next, examples of the toner of the present invention will be described, but the present invention is not limited by any of the following examples.

(a) Preparation of resin particle dispersion RL1

A monomer solution including 240.1 g of styrene, 59.9 g of n-butylacrylate, and 4.5 g of acrylic acid was dispersed in 440 g of ion-exchanged water with 7.2 g of nonionic surface-active agent (NONIPOL 400 manufactured by Sanyo Chemical Industries, Ltd.), 24 g of anionic surface-active agent (NEOGEN S20-F (20 wt % concentration), a substantial amount of anion: 4.8 g, manufactured by Dai-Ichi Kogyo Seiyaku Co., Ltd.), and 6 g of dodecanethiol. Then, 4.5 g of potassium persulfate was added to the resultant solution, and emulsion polymerization was performed at 75° C. for 4 hours, followed by an aging treatment at 90° C. for 2 hours. Thus, a resin particle dispersion RL1 was prepared in which the resin particles having Mn of 7200, Mw of 13800, Mz of 20500, Mp of 10800, Ts of 98° C., Tg of 52° C., and a median diameter of 0.14 μm were dispersed. The pH of this resin particle dispersion was 1.8.

Table 1 shows the characteristics of the binder resin obtained in each of the resin particle dispersions (RL1, RL2, RL3, RH1, RH2, rl4, rl5, rh3, and rh4) of the present invention that were prepared as examples of producing the resin particle dispersion. In Table 1, “Mn” represents a number-average molecular weight, “Mw” represents a weight-average molecular weight, “Mz” represents a Z-average molecular weight, “Mw/Mn” represents the ratio of the weight-average molecular weight (Mw) to the number-average molecular weight (Mn), “Mz/Mn” represents the ratio of the Z-average molecular weight (Mz) to the number-average molecular weight (Mn), “Mp” represents a peak value of the molecular weight, Tg (° C.) represents a glass transition point, and Ts (° C.) represents a softening point. Table 2 shows the amount of nonion (g) and the amount of anion (g) of the surface-active agents used for each of the resin particle dispersions, and the ratio (wt %) of the amount of nonion to the total amount of the surface-active agents. Table 3 shows the amounts of monomers or the like used in each of the resin particle dispersions (RL2, RL3, RH1, RH2, rl4, rl5, rh3, and rh4) for the emulsion polymerization, by the preparation of RL1.

TABLE 1

| | | | | | | | Heat characteristics | |
|---|---|---|---|---|---|---|---|---|
| Resin | Molecular weight characteristics | | | | | | Glass transition | Softening |
| particle | Mn | Mw | Mz | Wm = | Wz = | Mp | point | point |
| dispersion | (×10⁴) | (×10⁴) | (×10⁴) | Mw/Mn | Mz/Mn | (×10⁴) | Tg(° C.) | Ts(° C.) |
| RL1 | 0.72 | 1.38 | 2.05 | 1.92 | 2.85 | 1.08 | 52 | 98 |
| RL2 | 0.75 | 1.76 | 3.01 | 2.35 | 4.01 | 1.85 | 47 | 106 |
| RH1 | 1.43 | 5.14 | 18.90 | 3.59 | 13.22 | 5.80 | 58 | 144 |
| RH2 | 2.34 | 20.85 | 49.32 | 8.91 | 21.08 | 16.36 | 68 | 170 |
| rh3 | 0.26 | 2.83 | 9.62 | 10.88 | 37.00 | 0.27 | 43 | 135 |
| rh4 | 1.86 | 23.87 | 52.90 | 12.83 | 28.44 | 16.36 | 67 | 182 |

TABLE 2

| Resin | NONIPOL 400 | NEOGEN | Amount | Ratio of |
|---|---|---|---|---|
| particle | (Amount of | S20-F | of anion | nonion |
| dispersioin | nonion (g)) | (g) | (g) | (wt %) |
| RL1 | 7.2 | 24 | 4.8 | 60.0% |
| RL2 | 7.5 | 22.5 | 4.5 | 62.5% |
| RH1 | 6.5 | 27.5 | 5.5 | 54.2% |
| RH2 | 10.2 | 9 | 1.8 | 85.0% |
| rh3 | 5.5 | 32.5 | 6.5 | 45.8% |
| rh4 | 4.5 | 37.5 | 7.5 | 37.5% |

TABLE 3

| | | | | | | | | Emulsion | | Aging | | | |
|---|---|---|---|---|---|---|---|---|---|---|---|---|---|
| | | | | Ion | | | | polymerization | | treatment | | | pH of |
| Resin | | n-butyl | Acrylic | exchanged | Dodecane- | Carbon | Potassium | Temper- | | Temper- | | Median | resin |
| particle | Styrene | acrylate | acid | water | thiol | tetra- | persulfate | ature | Hour | ature | Hour | diameter | particle |
| dispersion | (g) | (g) | (g) | (g) | (g) | bromide | (g) | (° C.) | (h) | (° C.) | (h) | (μm) | dispersion |
| RL1 | 240.1 | 59.9 | 4.5 | 440 | 6 | 0 | 4.5 | 75 | 4 | 90 | 2 | 0.14 | 1.8 |
| RL2 | 230.1 | 69.9 | 4.5 | 440 | 6 | 0 | 4.5 | 75 | 4 | 90 | 5 | 0.18 | 1.9 |
| RH1 | 230.1 | 69.9 | 4.5 | 440 | 1.5 | 0 | 1.5 | 75 | 4 | 90 | 4 | 0.14 | 2 |
| RH2 | 235 | 65 | 4.5 | 440 | 0 | 0 | 3 | 80 | 4 | 90 | 2 | 0.18 | 1.8 |
| rh3 | 255 | 45 | 4.5 | 440 | 1.5 | 3 | 3 | 75 | 5 | 80 | 2 | 0.18 | 2 |
| rh4 | 255 | 45 | 4.5 | 440 | 0 | 0 | 3 | 80 | 5 | 90 | 2 | 0.16 | 2.1 |

### (3) Pigment Dispersion Production

(a) 308 g of ion-exchanged water and 12 g of nonionic surface-active agent (ELEMINOL NA 400 manufactured by Sanyo Chemical Industries, Ltd.) were weighed into a 1 liter beaker and stirred with a magnetic stirrer until the solid constituents of the surface-active agent was dissolved. Subsequently, 80 g of cyan pigment (KETBLUE111 manufactured by Dainippon Ink and Chemicals, Inc.) was added to the aqueous surface-active agent solution, and then was stirred for 10 minutes with the magnetic stirrer. Next, the content of the beaker was transferred to a 1 L tall beaker and dispersed using a homogenizer (T-25 manufactured by IKA CO., LTD.) at 9500 rpm for 10 minutes. This dispersion further was dispersed by a dispersing device (T.K. FILMICS: Model 56-50 manufactured by PRIMIX Corporation). The resultant dispersion was referred to as PM1. The pigment concentration was 20 wt %. Table 4 shows the pigments used in each of the pigment dispersions, by the control conditions of PM1.

TABLE 4

| | Pigment | |
|---|---|---|
| Color pigment | dispersion | Pigment used |
| Cyan pigment | PM1 | KETBLUE111 (Dainippon Ink and |
| | | Chemicals, Inc.) |
| Magenta pigment | PC1 | PERMANENT RUBINE F6B (Clariant) |
| Yellow pigment | PY1 | PY74 (Sanyo Color Works, Ltd.) |
| Black pigment | PB1 | #45L (Mitsubishi Chemical |
| | | Corporation) |

### (3) Wax Dispersion Production

(a) Preparation of Wax Particle Dispersion WA1

FIG. 3 is a schematic view of a stirring/dispersing device (T.K. FILMICS manufactured by PRIMIX Corporation), and FIG. 4 is a plan view of the same. As shown in FIG. 3, cooling water is introduced from 808 to the inside of an outer tank 801, and then is discharged from 807. Reference numeral 802 is a shielding board that stops the flow of the liquid to be treated. The shielding board 802 has an opening in the central portion, and the treated liquid is drawn from the opening and taken out of the device through 805. Reference numeral 803 is a rotating body that is secured to a shaft 806 and rotates at high speed. There are holes (about 1 to 5 mm in size) in the side of the rotating body 803, and the liquid to be treated can move through the holes. The liquid to be treated is put into the tank in an amount of about one-half the capacity (120 ml) of the tank. The maximum rotational speed of the rotating body 803 is 50 m/s. The rotating body 803 has a diameter of 52 mm, and the tank 801 has an internal diameter of 56 mm. Reference numeral 804 is a material inlet used for a continuous treatment. In the case of a high-pressure treatment or a batch treatment, the material inlet 804 is closed.

The tank was kept at atmospheric pressure, and 67 g of ion-exchanged water, 3 g of nonionic surface-active agent (ELEMINOL NA 400 manufactured by Sanyo Chemical Industries, Ltd.), 5 g of the first wax (W-1), and 25 g of the second wax (W-11) were blended and treated while the rotating body rotated at a rotational speed of 30 m/s for 5 minutes, and then 50 m/s for 2 minutes. Thus, a wax particle dispersion WA1 was provided. Tables 5, 6 and 7 show the wax materials and their characteristics used for the production of wax particle dispersions of the present invention that were prepared as examples of producing the wax particle dispersion.

TABLE 5

| | | Melting point | Heating loss | Iodine | Saponification |
|---|---|---|---|---|---|
| Wax | Material | Tmw1 (° C.) | Ck (wt %) | value | value |
| W-1 | Maximum hydrogenated jojoba oil | 68 | 2.8 | 2 | 95.7 |
| W-2 | Maximum hydrogenated meadowfoam oil | 71 | 2.5 | 2 | 90 |
| W-3 | Rice wax (LAXN300) | 79 | 3.1 | 5 | 95 |
| W-4 | Carnauba wax No. 1 | 84 | 1.5 | 8 | 88 |
| W-5 | Jojoba oil fatty acid pentaerythritol monoester | 84 | 3.4 | 2 | 120 |

TABLE 6

| | | Melting point | Heating loss |
|---|---|---|---|
| Wax | Material | Tmw1 (° C.) | Ck (wt %) |
| W-6 | Stearyl stearate | 58 | 2 |
| W-7 | Behenyl behenate | 74 | 1.2 |
| W-8 | Glycerol triester | 85 | 1.9 |
| | (hydrogenated castor oil) | | |

TABLE 7

| | | Melting point |
|---|---|---|
| Wax | Material | Tmw2 (° C.) |
| W-11 | Saturated hydrocarbon wax (FNP0080 | 81 |
| | manufactured by Nippon Seiro Co., Ltd.) | |
| W-12 | Fischer-Tropsch wax (manufactured by | 87 |
| | S. Kato & Co.) | |
| W-13 | Polyolefin wax (PE890 manufactured | 94 |
| | by Clariant) | |

Hereinafter, the types and characteristics of the waxes and the surface-active agents used in each of the wax particle dispersions (WA1 to WA8 and wa9 to wa15) based on the control conditions of WA1 are shown in Table 8. The “first wax” and the “second wax” represent the wax materials used in the wax particle dispersions, and the values in parentheses after the wax materials indicate the amount of composition of the mixed wax (weight ratio). As in the case of WA1, the total amount of the first and second waxes is 30 g. Moreover, “PR16” indicates the particle size when the value cumulated from the smaller particle diameter side reaches 16% in the volume-based particle size distribution of the wax particles in the wax particle dispersion. Similarly, “PR50” indicates 50% diameter and “PR84” indicates 84% diameter. “PR84/PR16” indicates the ratio of the 84% diameter (PR84) to the 16% diameter (PR16).

TABLE 8

| | Wax | | | | | |
|---|---|---|---|---|---|---|
| Wax | Composition | | Particle size of dispersed particles | | | |
| particle | First | Second | PR16 | PR50 | PR80 | PR84/ |
| dispersion | wax | wax | (nm) | (nm) | (nm) | PR16 |
| WA1 | W-1(1) | W-11(5) | 98 | 133 | 168 | 1.71 |
| WA2 | W-2(1) | W-12(2) | 109 | 159 | 209 | 1.92 |
| WA3 | W-3(1) | W-13(1) | 198 | 293.5 | 389 | 1.96 |
| WA4 | W-4(1) | W-13(2) | 187 | 272.5 | 358 | 1.91 |
| WA5 | W-5(1) | W-13(4) | 108 | 148.5 | 189 | 1.75 |
| WA6 | W-6(1) | W-11(2) | 110 | 158 | 206 | 1.87 |
| WA7 | W-7(1) | W-12(2) | 112 | 160 | 208 | 1.86 |
| WA8 | W-8(1) | W-13(3) | 124 | 187 | 246 | 1.99 |
| wa9 | W-4(1) | None | 112 | 155 | 198 | 1.77 |
| wa10 | W-7(1) | None | 168 | 236 | 304 | 1.81 |
| wa11 | None | W-11(1) | 168 | 250 | 332 | 1.98 |
| wa12 | None | W-12(1) | 168 | 240 | 312 | 1.86 |
| wa13 | W-7(3) | W-11(2) | 198 | 304 | 410 | 2.07 |
| wa14 | W-3(3) | W-11(2) | 132 | 199.5 | 267 | 2.02 |
| wa15 | W-6(1) | W-12(5) | 119 | 208.5 | 298 | 2.50 |

Table 9 shows the amount of nonion (g) and the amount of anion (g) of the surface-active agents used for each of the wax particle dispersions, and the ratio (wt %) of the amount of nonion to the total amount of the surface-active agents.

TABLE 9

| Wax | Amount of | Amount of | Ratio of | Amount of | Amount of |
|---|---|---|---|---|---|
| particle | nonion | anion | nonion | first wax | second wax |
| dispersion | (g) | (g) | (wt %) | (g) | (g) |
| WA1 | 2 | 1 | 67% | 5 | 25 |
| WA2 | 1.8 | 1.2 | 60% | 10 | 20 |
| WA3 | 2.5 | 0.5 | 83% | 15 | 15 |
| WA4 | 2.7 | 0.3 | 90% | 10 | 20 |
| WA5 | 3 | 0 | 100% | 6 | 24 |
| WA6 | 3 | 0 | 100% | 5 | 25 |
| WA7 | 1.8 | 1.2 | 60% | 5 | 25 |
| WA8 | 3 | 0 | 100% | 7.5 | 22.5 |
| wa9 | 3 | 0 | 100% | 30 | None |
| wa10 | 3 | 0 | 100% | 30 | None |
| wa11 | 3 | 0 | 100% | None | 30 |
| wa12 | 3 | 0 | 100% | None | 30 |
| wa13 | 1 | 2 | 33% | 18 | 12 |
| wa14 | 1.4 | 1.6 | 47% | 5 | 25 |
| wa15 | 0 | 3 | 0% | 5 | 25 |

When the anionic surface-active agent (NEOGEN S20-F (20 wt % concentration) manufactured by Dai-Ichi Kogyo Seiyaku Co., Ltd.) was used, the amount of the ion-exchanged water was adjusted so that the pigment concentration was set to about 20 wt %. In Table, the weight ratio indicates the substantial ratio of anion, and the total amount of the surface-active agents is the same in each of the dispersions.

### (5) Toner Base Production

(a) Preparation of Toner Base M1

In a 2 L cylindrical glass container equipped with a thermometer, a cooling tube, a pH meter, and a stirring blade were placed 204 g of the first resin particle dispersion RL1, 40 g of the cyan pigment particle dispersion PCd, 30 g of the wax particle dispersion WA1, and 150 ml of ion-exchanged water, and then mixed for 10 minutes by using a homogenizer (Ultratalax T25 manufactured by IKA CO., LTD.). Thus, a mixed particle dispersion was prepared.

Then, the pH was increased to 11.5 by adding 1N NaOH to the mixed dispersion, and this was stirred for 10 minutes. Subsequently, the temperature was raised from 20° C. at a rate of 1° C./min. When the temperature reached 80° C. (at which the pH of the mixed dispersion was 10.1), 800 g of magnesium sulfate aqueous solution with an adjusted pH of 9.0 and a concentration of 23 wt % was dropped to the mixed dispersion continuously for a duration of 30 minutes and heat-treated for 1 hour. Thereafter, the temperature was raised to 90° C., and the mixture was heat-treated for 3 hours, thus forming core particles. The pH of the core particle dispersion was 8.2. Moreover, the water temperature was raised to 92° C., and then 100 g of the second resin particle dispersion RH1 with an adjusted pH of 8.5 was added dropwise to the core particle dispersion. After completion of the dropping, this mixture was heat-treated for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, so that the volume-average particle size was 3.7 μm and the coefficient of variation was 16.3.

Toner bases M2, M4, and M5 were produced by the conditions of M1, although the wax particle dispersion was changed, and the aggregation properties of the core particles were observed.

(b) Preparation of Toner Base M3

In a 2 L cylindrical glass container equipped with a thermometer, a cooling tube, a pH meter, and a stirring blade were placed 204 g of the first resin particle dispersion RL1, 36 g of the cyan pigment particle dispersion PC1, 40 g of the wax particle dispersion WA3, and 150 ml of ion-exchanged water, and then mixed for 10 minutes by using a homogenizer (Ultratalax T25 manufactured by IKA CO., LTD.). Thus, a mixed particle dispersion was prepared.

Then, the pH was increased to 9.7 by adding 1N NaOH to the mixed dispersion, and this was stirred for 10 minutes. Subsequently, the temperature was raised from 20° C. at a rate of 1° C./min. When the temperature reached 80° C. (at which the pH of the mixed dispersion was 8.4), 800 g of magnesium sulfate aqueous solution with an adjusted pH of 5.4 and a concentration of 23 wt % was dropped to the mixed dispersion continuously for a duration of 100 minutes and heat-treated for 1 hour. Thereafter, the temperature was raised to 90° C., and the mixture was heat-treated for 3 hours, thus forming core particles. The pH of the core particle dispersion was 7.0.

Moreover, the water temperature was raised to 92° C., and then 70 g of the second resin particle dispersion RH1 with an adjusted pH of 6.8 was added dropwise to the core particle dispersion. After completion of the dropping, this mixture was heat-treated for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, so that the volume-average particle size was 6.7 μm and the coefficient of variation was 16.9.

Toner base M6 was produced by the conditions of M3, although the wax particle dispersion was changed, and the aggregation properties of the core particles were observed.

(c) Preparation of Toner Base M7

In a 2 L cylindrical glass container equipped with a thermometer, a cooling tube, a pH meter, and a stirring blade were placed 204 g of the first resin particle dispersion RL1, 44 g of the cyan pigment particle dispersion PC1, 50 g of the wax particle dispersion WA7, and 150 ml of ion-exchanged water, and then mixed for 10 minutes by using a homogenizer (Ultratalax T25 manufactured by IKA CO., LTD.). Thus, a mixed particle dispersion was prepared.

Then, the pH was increased to 11.5 by adding 1N NaOH to the mixed dispersion, and 900 g of magnesium sulfate aqueous solution with a concentration of 23 wt % was added to the mixed dispersion and stirred for 10 minutes. Subsequently, the temperature was raised from 20° C. to 90° C. at a rate of 1° C./min. Thereafter, the mixture was heat-treated for 3 hours, thus forming core particles. The pH of the core particle dispersion was 9.1.

Moreover, the water temperature was raised to 92° C., and then 120 g of the second resin particle dispersion RH1 with an adjusted pH of 6.8 was added dropwise to the core particle dispersion. After completion of the dropping, this mixture was heat-treated for 1.5 hours, thereby providing particles fused with the second resin particles.

After cooling, the reaction product (toner base) was filtered and washed three times with ion-exchanged water. The toner base thus obtained was dried at 40° C. for 6 hours by using a fluid-type dryer, so that the volume-average particle size was 4.9 μm and the coefficient of variation was 19.1.

Toner bases M8 and m9 to m17 were produced by the conditions of M6, although the wax particle dispersion was changed.

The toner base m16 was produced by adding 15 g of the wax particle dispersion wa7 and 30 g of the wax particle dispersion wa4 separately. The toner base m17 was produced by adding 15 g of the wax particle dispersion wa10 and 30 g of the wax particle dispersion wa12 separately.

Table 10 shows the compositions and the characteristics of each of the toner bases (M1 to M8) of the present invention and the comparative toner bases (m9 to m17) that were prepared as examples of producing the toner base. Table 11 shows the volume-average particle size d50 (μm) of the toner base particles, the coefficient of variation that indicates the degree of expansion of the volume-based particle size distribution of the toner base particles in each of the toner bases, Jmw1/Jw 1, Jmw2/Jw2, and the aggregation properties of the core particles.

TABLE 10

| | Composition | | | | | | | | | |
|---|---|---|---|---|---|---|---|---|---|---|
| | First resin | | Colorant | | Wax | | Second resin | | Amount of | |
| | particle | Amount | particle | Amount | particle | Amount | particle | Amount | MgSO₄ | Ion-exchanged |
| Toner base | dispersion | added (g) | dispersion | added (g) | dispersion | added (g) | dispersion | added (g) | solution | water |
| M1 | RL1 | 204 | PC1 | 40 | WA1 | 30 | RH1 | 100 | 800 | 150 |
| M2 | RL1 | 204 | PC1 | 43 | WA2 | 45 | RH1 | 120 | 900 | 150 |
| M3 | RL1 | 204 | PC1 | 36 | WA3 | 40 | RH2 | 70 | 800 | 150 |
| M4 | RL2 | 204 | PC1 | 36 | WA4 | 25 | RH2 | 70 | 800 | 150 |
| M5 | RL2 | 204 | PC1 | 43 | WA5 | 45 | RH1 | 120 | 900 | 150 |
| M6 | RL1 | 204 | PC1 | 43 | WA6 | 40 | RH1 | 120 | 900 | 150 |
| M7 | RL1 | 204 | PC1 | 44 | WA7 | 50 | RH1 | 130 | 900 | 150 |
| M8 | RL1 | 204 | PC1 | 36 | WA8 | 40 | RH2 | 70 | 800 | 150 |
| m9 | RL2 | 204 | PC1 | 36 | wa9 | 40 | RH2 | 70 | 800 | 150 |
| m10 | RL2 | 204 | PC1 | 43 | wa10 | 35 | RH1 | 120 | 900 | 150 |
| m11 | RL1 | 204 | PC1 | 43 | wa11 | 40 | RH1 | 120 | 900 | 150 |
| m12 | RL1 | 204 | PC1 | 36 | wa12 | 40 | RH2 | 70 | 800 | 150 |
| m13 | RL2 | 204 | PC1 | 36 | wa13 | 40 | rh4 | 70 | 800 | 150 |
| m14 | RL1 | 204 | PC1 | 43 | wa14 | 30 | rh3 | 120 | 900 | 150 |
| m15 | RL2 | 204 | PC1 | 36 | wa15 | 30 | rh4 | 70 | 800 | 150 |
| m16 | RL1 | 204 | PC1 | 43 | wa7/wa4 | 15/30 | RH1 | 120 | 900 | 150 |
| m17 | RL1 | 204 | PC1 | 43 | wa10/wa12 | 15/30 | RH1 | 120 | 900 | 150 |

TABLE 11

| | Toner base particles | | | | |
|---|---|---|---|---|---|
| | | Volume-based | | | |
| Toner | | coefficient of | | | Aggregation properties of |
| base | d50(μm) | variation | Jmw1/Jw1 | Jmw2/Jw2 | core particles |
| M1 | 3.7 | 15.9 | 0.09 | 0.58 | A (clear after 2 h) |
| M2 | 3.8 | 16.1 | 0.43 | 0.69 | A (clear after 2 h) |
| M3 | 6.7 | 16.9 | 0.27 | 0.65 | A (clear after 3 h) |
| M4 | 4.2 | 17.9 | 0.24 | 0.65 | A (clear after 3 h) |
| M5 | 3.9 | 15.4 | 0.37 | 0.60 | A (clear after 2 h) |
| M6 | 6.8 | 17.4 | 0.30 | 1.17 | A (clear after 3 h) |
| M7 | 4.9 | 19.1 | 0.34 | 0.8 | A (clear after 3 h) |
| M8 | 4.9 | 20.1 | 0.34 | 1.10 | A (clear after 3 h) |
| m9 | 8.7 | 25.7 | 0.73 | | B (slightly clouded after 6 h) |
| m10 | 9.7 | 23.5 | 0.68 | | B (slightly clouded after 6 h) |
| m11 | 8.2 | 25.8 | | 0.95 | C (clouded after 6 h) |
| m12 | 7.2 | 27.1 | | 0.89 | C (clouded after 6 h) |
| m13 | 11.2 | 32.8 | 0.78 | 0.98 | C (clouded after 6 h) |
| m14 | 10.3 | 34.9 | 1.62 | 1.48 | C (clouded after 6 h) |
| m15 | 12.9 | 33.8 | 0.81 | 0.93 | C (clouded after 6 h) |
| m16 | 13.9 | 32.2 | 0.19 | 0.41 | C (clouded after 6 h) |
| m17 | 16.9 | 37.1 | 0.69 | 0.91 | C (clouded after 6 h) |

In the process of producing the toner by aggregating and fusing the emulsified resin particles, the pigment particles, and the wax particles, the decision whether the pigment particles and the wax particles are incorporated into the toner while being surrounded by the resin particles can be made in such a manner that the reaction liquid during the aggregation and fusion is taken at predetermined time intervals and subjected to centrifugal separation. If the pigment particles and the wax particles are incorporated into the toner, the reaction liquid is separated into two layers of solid and liquid, and the supernatant liquid becomes colorless and transparent. If the wax particles are not incorporated into the toner, the supernatant liquid becomes clouded. If the pigment particles are not incorporated into the toner, the supernatant liquid shows a color of the pigment. For example, the color of the supernatant liquid is cyan in the case of a cyan toner and is black in the case of a black toner.

In order to evaluate the aggregation properties of the core particles, the dispersion during the aggregation reaction was sampled and diluted with the same amount of ion-exchanged water, and then the diluted sample was placed in a test tube of a centrifuge that was rotated at 3000 min⁻¹ for 5 minutes. After the centrifugal separation, the turbidity of the supernatant liquid was measured by visual inspection.

In M1 to M8, the supernatant liquid became clear after 2 to 3 hours, and the toner base particles had a small particle size and a narrow particle size distribution. The value of Jmw1/Jw1 was 0.09 to 0.43, and the endotherm of the first wax by the MDSC method was reduced to 0.5 or less compared to the DSC method. The value of Jmw2/Jw2 was 0.58 to 1.17, and the degree of reduction in the endotherm of the second wax by the MDSC method with respect to the DSC method was smaller than that of the first wax, namely Jmw2/Jw2 was 0.5 or more.

In Table 11, the values of Jmw2/Jw2 of M6 and M8 are 1.0 or more. This is attributed to a large amount of heat generated during crystallization because the second wax having a high melting point is used at a predetermined mixing ratio or more. The heat generation due to the crystallization is detected by the DSC method, and a part of the endotherm in the DSC method is canceled out by the amount of heat generated during the crystallization. On the other hand, the MDSC method does not detect a heat generation due to crystallization, which is a thermal relaxation phenomenon, and therefore the endotherm is not canceled out. Thus, since the endotherm is larger in the MDSC method than in the DSC method, it can be considered that the ratio of the endotherm in the MDSC method to the endotherm in the DSC method is 1.0 or more.

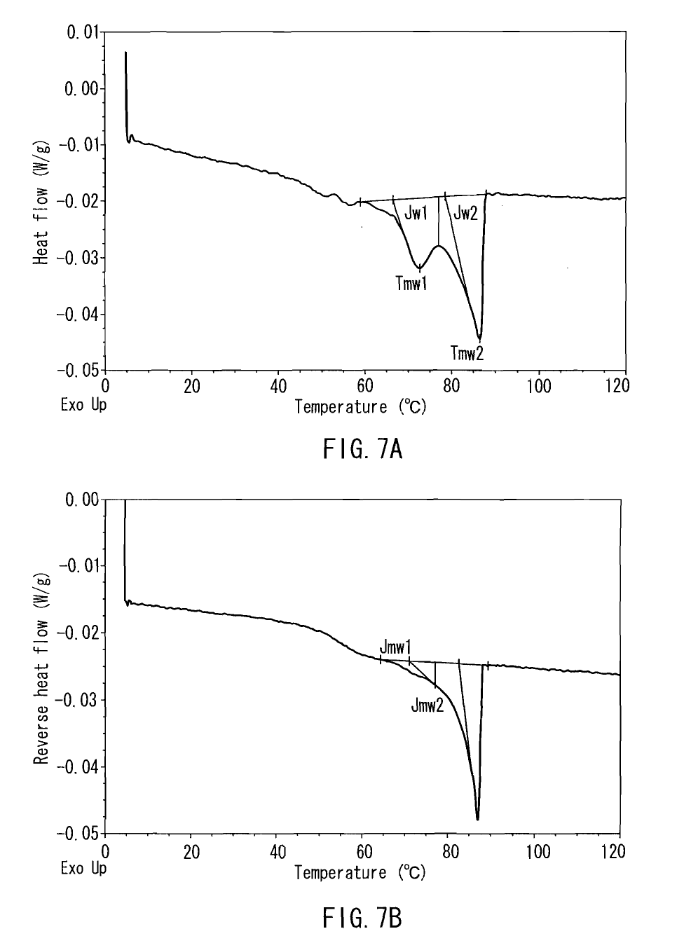

FIG. 7A shows the DSC endothermic curve of the toner base M7 and FIG. 7B shows the MDSC endothermic curve of the toner base M7. Under the measurement conditions of the DSC method, the heating rate was 1° C./min. In general, for the DSC measurement, the sample is once heated and cooled to remove the thermal history, and then is heated again while the endotherm is measured. However, it was expected that the structure of the sample would be changed by melting. Therefore, the heating and cooling processes for removal of the thermal history were omitted.

Under the measurement conditions of the MDSC method, the average heating rate was 1° C./min, the modulation period was 40 seconds, and the temperature modulation amplitude was 0.106° C. In this case, the heating rate ranged periodically from a minimum of 0° C./min to a maximum of 2° C./min. The measurement temperature range was 5° C. to 120° C. in both the DSC and MDSC methods.

As shown in FIGS. 7A and 7B, when the endothermic region of the first wax overlapped with that of the second wax, the endotherms of the first and second waxes were calculated by using as a boundary the temperature at which the DSC endothermic curve had a minimum value between the endothermic peak temperature (melting point Tmw1 (° C.)) of the first wax and the endothermic peak temperature (melting point Tmw2 (° C.)) of the second wax.

In m9 and m10 using only the first wax, the supernatant liquid was not likely to be sufficiently clear even after 6 hours of the aggregation reaction, and the liquid remained clouded due to the wax particles that were not yet aggregated but were present in the liquid. Also, in m11 and m12 using only the second wax, the supernatant liquid was not likely to be sufficiently clear even after 6 hours of the aggregation reaction, and the liquid remained clouded due to the wax particles that were not yet aggregated but were present in the liquid. In Table 11, the evaluation of the transparency of the liquid after the aggregation reaction is represented by A, B and C: “A” indicates a good state in which there is almost no wax particle that is not aggregated but suspended in the liquid; “B” indicates a state in which the transmittance is 40% to 80% when the liquid is irradiated with red light having a wavelength of 635 nm by using a 1 mW laser pointer, although the supernatant liquid is clouded; and “C” indicates a state in which the transmittance measured in the above manner is less than 40%.

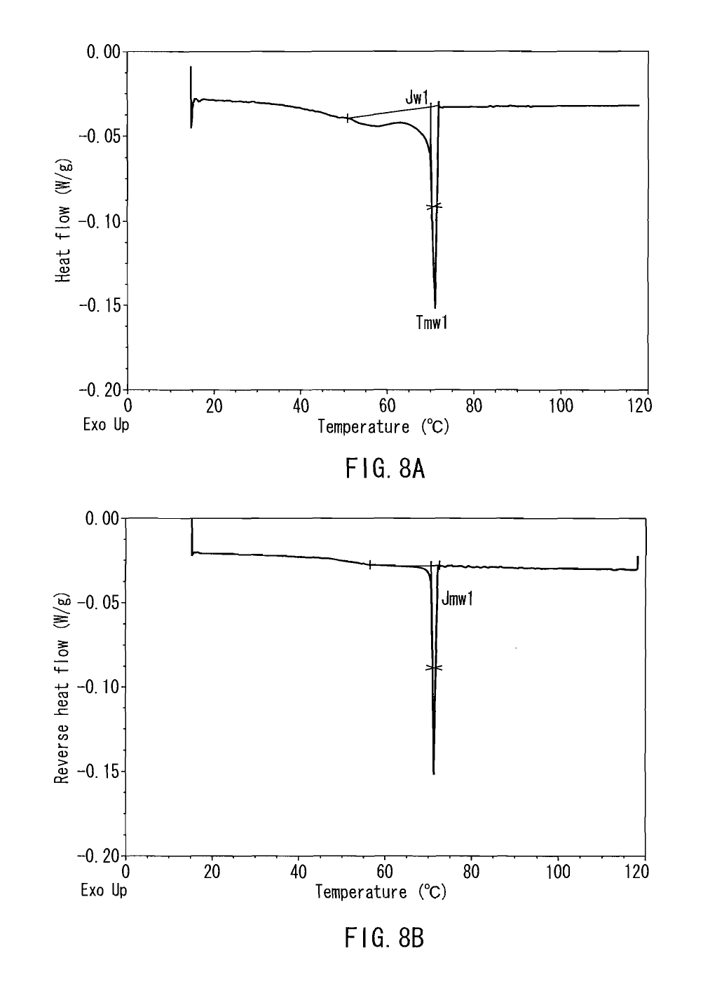

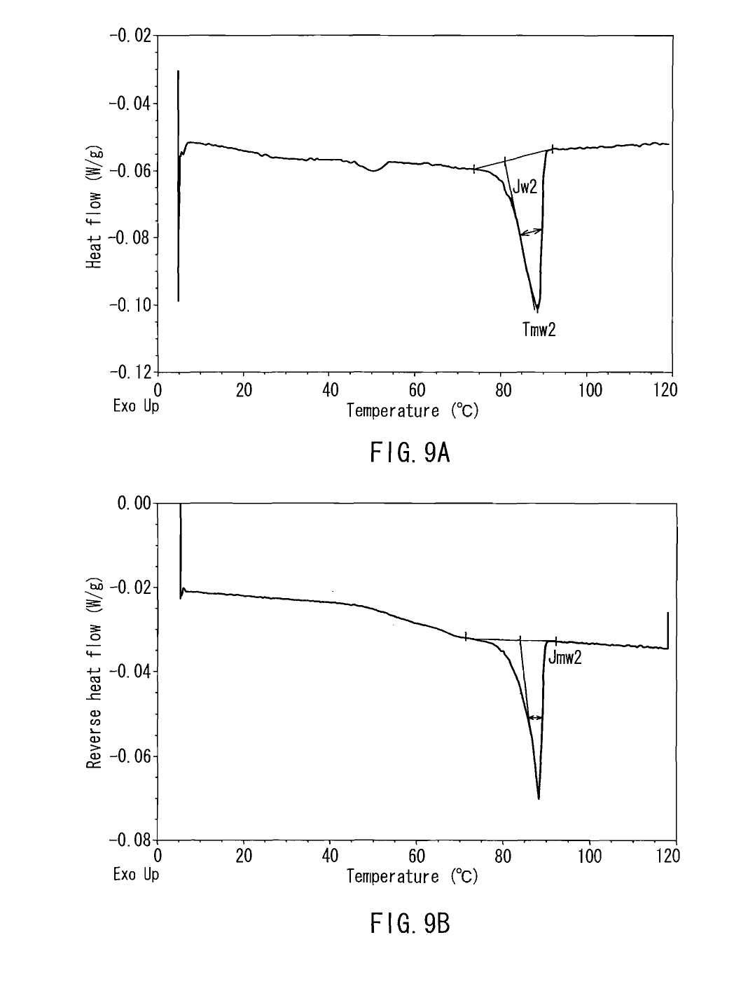

FIG. 8A shows the DSC endothermic curve of the toner base m10 and FIG. 8B shows the MDSC endothermic curve of the toner base m10. FIG. 9A shows the DSC endothermic curve of the toner base m12 and FIG. 9B shows the MDSC endothermic curve of the toner base m12. When the first wax and the second wax are used individually, as shown in FIGS. 8A, 8B, 9A, and 9B, the endothermic peak is observed even in the analysis of the MDSC method similarly to the analysis of the DSC method, and no reduction in the endothermic peak by the MDSC method is observed.

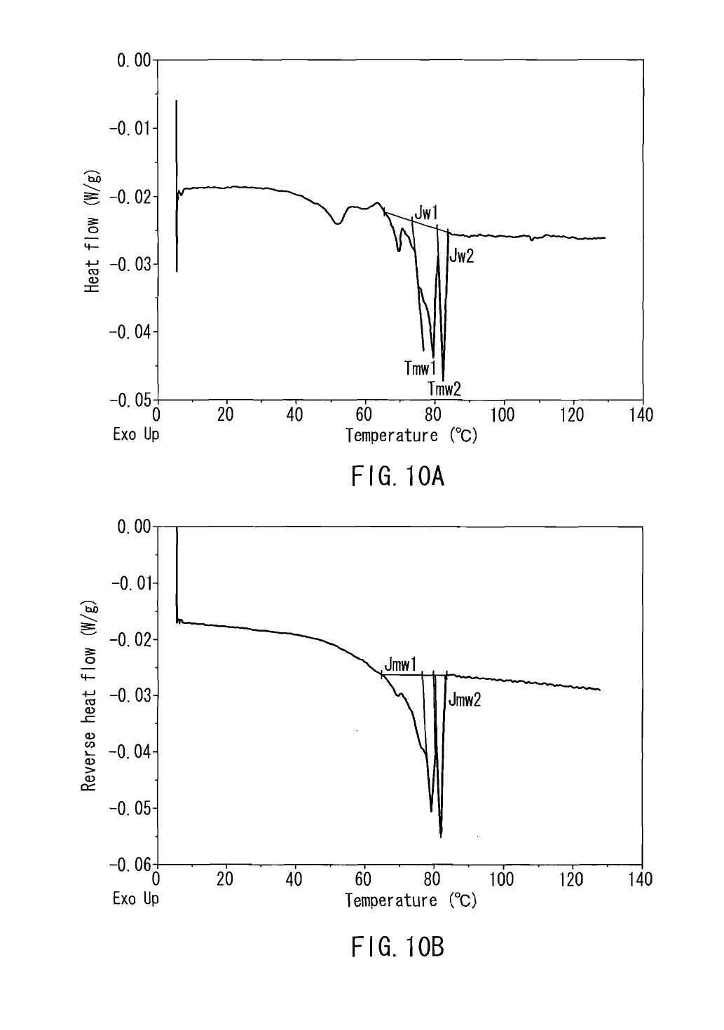

In the toner base m14 using the wax particle dispersion wa14, the supernatant liquid was not likely to be sufficiently clear even after 6 hours of the aggregation reaction, and the liquid remained clouded due to the wax particles that were not yet aggregated but were present in the liquid. FIG. 10A shows the DSC endothermic curve of the toner base m14 and FIG. 10B shows the MDSC endothermic curve of the toner base m 14. The resin particles and the wax particles are neither dispersed uniformly nor compatible with each other, so that the values of Jmw1/Jw1 and Jmw2/Jw2 are as high as 1.0 or more. Such high values are attributed to a large amount of heat generated during crystallization of the waxes. Also, in the toner base m13 and the toner base m15 using the wax particle dispersions wa13 and wa15, respectively, the supernatant liquid was not likely to be sufficiently clear even after 6 hours of the aggregation reaction, and the liquid remained clouded due to the wax particles that were not yet aggregated but were present in the liquid. The resin particles and the wax particles were neither dispersed uniformly nor compatible with each other, so that the value of Jmw1/Jw1 is 0.5 or more, and the value of Jmw2/Jw2 is high as well.

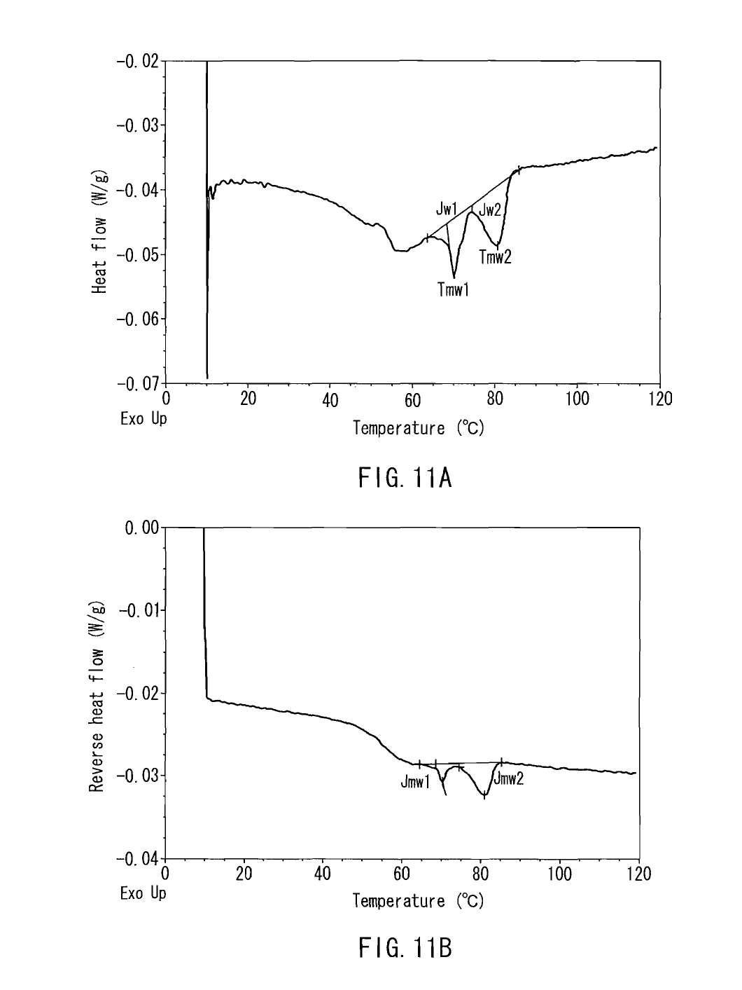

In the toner base m16, the supernatant liquid was not likely to be sufficiently clear even after 6 hours of the aggregation reaction, and the liquid remained clouded due to the wax particles that were not yet aggregated but were present in the liquid. FIG. 11A shows the DSC endothermic curve of the toner base m16 and FIG. 11B shows the MDSC endothermic curve of the toner base m16. The degree of reduction in the endotherm of the second wax by the MDSC method with respect to the DSC method is the same as that of the first wax, namely Jmw2/Jw2 is 0.5 or less. This may be because the wax particles having a high-melting point are compatible with the resin particles, and thus the high-temperature offset resistance during fixing tends to be weaker.

### (6) Additive

Next, examples of the additives will be described. Table 12 shows the materials and characteristics of each of additives (S1, S2, S3, S4, S5, S6, S7, S8 and S9) used in this example.

TABLE 12

| Inorganic | | | | Particle | Methanol | Moisture | Ignition | Drying | 5-min | 30-min | 5-min/ |
|---|---|---|---|---|---|---|---|---|---|---|---|
| fine | | Treatment | Treatment | size | titration | absorption | loss | loss | value | value | 30-min |
| powder | Material | material A | material B | (nm) | (%) | (wt %) | (wt %) | (wt %) | (μC/g) | (μC/g) | value |
| S1 | Silica | Silica treated with | | 6 | 88 | 0.1 | 10.5 | 0.2 | −820 | −710 | 86.59 |
| | | dimethylpolysiloxane | | | | | | | | | |
| S2 | Silica | Silica treated with | | 16 | 88 | 0.1 | 5.5 | 0.2 | −560 | −450 | 80.36 |
| | | methyl hydrogen | | | | | | | | | |
| | | polysiloxane | | | | | | | | | |
| S3 | Silica | Methyl hydrogen | | 40 | 88 | 0.1 | 10.8 | 0.2 | −580 | −480 | 82.76 |
| | | polysiloxane (1) | | | | | | | | | |
| S4 | Silica | Dimethylpolysiloxane | Aluminum | 40 | 84 | 0.09 | 24.5 | 0.2 | −740 | −580 | 78.38 |
| | | (20) | distearate (2) | | | | | | | | |
| S5 | Silica | Methyl hydrogen | Stearic acid | 40 | 88 | 0.1 | 10.8 | 0.2 | −580 | −480 | 82.76 |
| | | polysiloxane (1) | amide (1) | | | | | | | | |
| S6 | Silica | Dimethylpolysiloxan | Fatty acid | 80 | 88 | 0.12 | 15.8 | 0.2 | −620 | −475 | 76.61 |
| | | (2) | pentaerythritol | | | | | | | | |
| | | | monoester (1) | | | | | | | | |
| S7 | Silica | Methyl hydrogen | | 150 | 89 | 0.10 | 6.8 | 0.2 | −580 | −480 | 82.76 |
| | | polysiloxane (1) | | | | | | | | | |
| S8 | Titanium | Diphenylpolysiloxan | Sodium | 80 | 88 | 0.1 | 18.5 | 0.2 | −750 | −650 | 86.67 |
| | oxide | (10) | stearate (1) | | | | | | | | |
| S9 | Silica | Silica treated with | | 16 | 68 | 0.60 | 1.6 | 0.2 | −800 | −620 | 77.50 |
| | | hexamethyldisilazane | | | | | | | | | |

In Table 12, when a plurality of types of treatment materials 1 and 2 are used, the mixing weight ratio of the treatment materials 1 and 2 is shown in parentheses. The “5-minute value” and the “30-minute value” representing the charge amount ([μC/g]) were measured by a blow-off method using frictional charge with an uncoated ferrite carrier. Specifically, under the environmental conditions of 25° C. and 45% RH, 50 g of carrier and 0.1 g of silica or the like were mixed in a 100 ml polyethylene container, and then stirred by vertical rotation at a speed of 100 min⁻¹ for 5 minutes and 30 minutes, respectively. Thereafter, 0.3 g of a sample was taken for each stirring time, and a nitrogen gas was blown on the samples at 1.96×10⁴ [Pa] for 1 minute.

It is preferable that the 5-minute value is −100 to −800 μC/g and the 30-minute value is −50 to −600 μC/g for the negative chargeability. Silica having a high charge amount can exhibit such characteristics in a small quantity.

The treatment materials A, B were dissolved and dispersed in a solvent by using a Henschel mixer FM20B (manufactured by Mitsui Mining Co., Ltd.), and mixed with additive, followed by removal of the solvent. The amount of the treatment materials was 10 parts by weight per 100 parts by weight of the additive. The values in parentheses of the treatment materials A, B indicate the mixing ratio of A to B.

Table 13 shows the composition of materials used for each of the toners of this example. The compositions of magenta, black, and yellow toners were the same as the composition of a cyan toner except that PM1, PB1, and PY1 were used as pigments, respectively.

TABLE 13

| | Configuration | | | |
|---|---|---|---|---|
| | | Additives | | |
| Toner | Toner base | Additive A | Additive B | Additive C |
| TM1 | M1 | S1(0.6) | S3(2.5) | None |
| TM2 | M2 | S2(1.8) | S4(1.5) | None |
| TM3 | M3 | S1(1.8) | S5(1.2) | None |
| TM4 | M4 | S2(2.5) | None | None |
| TM5 | M5 | S1(2.0) | S6(2.0) | None |
| TM6 | M6 | S2(1.8) | S7(3.5) | None |
| TM7 | M7 | S1(0.6) | S8(2.0) | S7(1.5) |
| TM8 | M8 | S1(0.6) | S7(3.5) | S7(1.5) |
| tm9 | m9 | S2(1.8) | S4(1.5) | None |
| tm10 | m10 | S2(1.8) | S4(1.5) | None |
| tm11 | m11 | S1(1.0) | S6(2.0) | None |
| tm12 | m12 | S1(1.0) | S7(3.0) | None |
| tm13 | m13 | S1(0.6) | None | None |
| tm14 | m14 | S2(2.5) | None | None |
| tm15 | m15 | S2(2.5) | None | None |
| tm16 | m16 | S1(0.6) | None | None |
| tm17 | m17 | S9(0.5) | None | None |

The values in parentheses after the additives indicate the amount (parts by weight) of the additive per 100 parts by weight of the toner base. The addition treatment was performed by using a Henschel mixer FM20B (manufactured by Mitsui Mining Co., Ltd.) with a Z0S0-type mixer blade, an input amount of 1 kg, a number of revolutions of 2000 min⁻¹, and a treating time of 5 minutes.

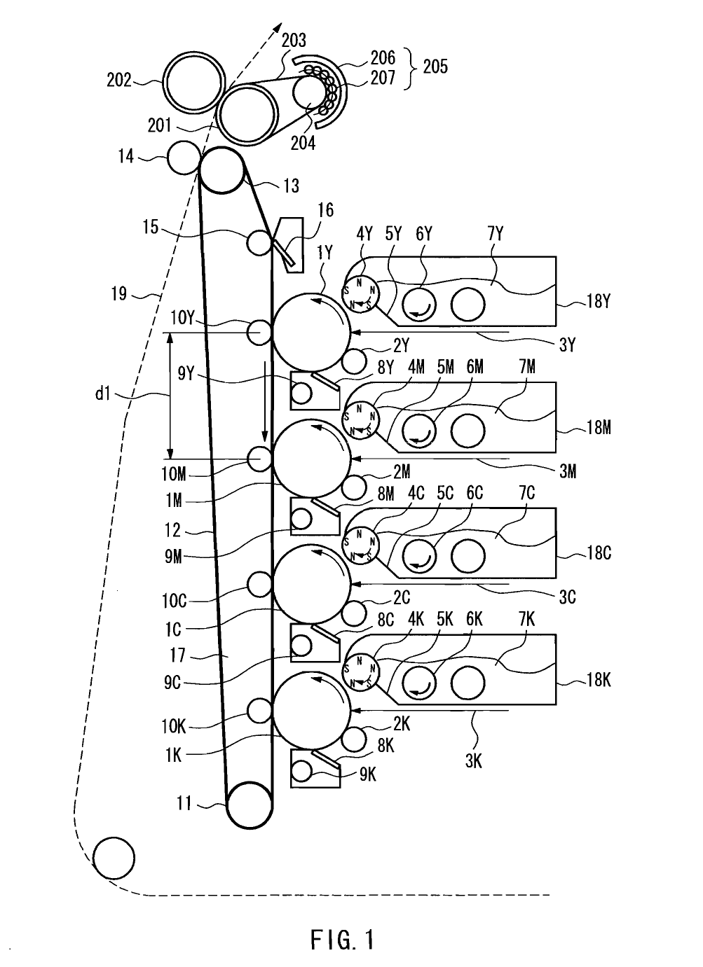

FIG. 1 is a cross-sectional view showing the configuration of a full color image forming apparatus used in this example. In FIG. 1, the outer housing of a color electrophotographic printer is not shown. A transfer belt unit 17 includes a transfer belt 12, a first color (yellow) transfer roller 10Y, a second color (magenta) transfer roller 10M, a third color (cyan) transfer roller 10C, a fourth color (black) transfer roller 10K, a driving roller 11 made of aluminum, a second transfer roller 14 made of an elastic body, a second transfer follower roller 13, a belt cleaner blade 16 for cleaning a toner image that remains on the transfer belt 12, and a roller 15 located opposite to the belt cleaner blade 16. The first to fourth color transfer rollers 10Y, 10M, 10C, and 10K are made of an elastic body. A distance between the first color (Y) transfer position and the second color (M) transfer position is 70 mm (which is the same as a distance between the second color (M) transfer position and the third color (C) transfer position and a distance between the third color (C) transfer position and the fourth color (K) transfer position). The circumferential velocity of a photoconductive member is 125 mm/s.

The transfer belt 12 can be obtained by kneading a conductive filler in an insulating resin and making a film with an extruder. In this example, polycarbonate resin (e.g., European Z300 manufactured by Mitsubishi Gas Kagaku Co., Ltd.) was used as the insulating resin, and 5 parts by weight of conductive carbon (e.g., “KETJENBLACK”) were added to 95 parts by weight of the polycarbonate resin to form a film. The surface of the film was coated with a fluorocarbon resin. The film had a thickness of about 100 μm, a volume resistance of 10⁷ to 10¹²Ω·cm, and a surface resistance of 10⁷ to 10¹²Ω/□ (square). The use of this film can improve the dot reproducibility and prevent slackening of the transfer belt 12 over a long period of use and charge accumulation effectively. By coating the film surface with a fluorocarbon resin, the filming of the toner on the surface of the transfer belt 12 due to a long period of use also can be suppressed effectively. If the volume resistance is less than 10⁷Ω·cm, retransfer is likely to occur. If the volume resistance is more than 10¹²Ω·cm, the transfer efficiency is degraded.

A first transfer roller 10 is a conductive polyurethane foam including carbon black and has an outer diameter of 8 mm. The resistance value is 102 to 106Ω. In the first transfer operation, the first transfer roller 10 is pressed against a photoconductive member 1 with a force of about 1.0 to 9.8 (N) via the transfer belt 12, so that the toner is transferred from the photoconductive member 1 to the transfer belt 12. If the resistance value is less than 102Ω, retransfer is likely to occur. If the resistance value is more than 106Ω, a transfer failure is likely to occur. The force less than 1.0 (N) may cause a transfer failure, and the force more than 9.8 (N) may cause transfer voids.

The second transfer roller 14 is a conductive polyurethane foam including carbon black and has an outer diameter of 10 mm. The resistance value is 10² to 10⁶Ω. The second transfer roller 14 is pressed against the follower roller 13 via the transfer belt 12 and a transfer medium 19 such as a paper or OHP sheet. The follower roller 13 is rotated in accordance with the movement of the transfer belt 12. In the second transfer operation, the second transfer roller 14 is pressed against the follower roller 13 with a force of 5.0 to 21.8 (N), so that the toner is transferred from the transfer belt 12 to the transfer medium 19. If the resistance value is less than 10²Ω, retransfer is likely to occur. If the resistance value is more than 10⁶Ω, a transfer failure is likely to occur. The force less than 5.0 (N) may cause a transfer failure, and the force more than 21.8 (N) may increase the load and generate jitter easily.

Four image forming units 18Y, 18M, 18C, and 18K for yellow (Y), magenta (M), cyan (C), and black (K) are arranged in series, as shown in FIG. 1.

The image forming units 18Y, 18M, 18C, and 18K have the same components except for a developer contained therein. For simplification, only the image forming unit 18Y for yellow (Y) will be described, and an explanation of the other units will not be repeated.

The image forming unit is configured as follows. Reference numeral 1 is a photoconductive member, 3 is pixel laser signal light, and 4 is a developing roller of aluminum that has an outer diameter of 10 mm and includes a magnet with a magnetic force of 1200 gauss. The developing roller 4 is located opposite to the photoconductive member 1 with a gap of 0.3 mm between them, and rotates in the direction of the arrow. A stirring roller 6 stirs the toner and a carrier in a developing unit and supplies the toner to the developing roller 4. The mixing ratio of the toner to the carrier is read from a permeability sensor (not shown), and the toner is supplied as needed from a toner hopper (not shown). A magnetic blade 5 is made of metal and controls a magnetic brush layer of a developer on the developing roller 4. In this example, 150 g of developer was introduced, and the gap was 0.4 mm. Although a power supply is not shown in FIG. 1, a direct voltage of −500 V and an alternating voltage of 1.5 kV (p-p) at a frequency of 6 kHz were applied to the developing roller 4. The circumferential velocity ratio of the photoconductive member 1 to the developing roller 4 was 1:1.6. The mixing ratio of the toner to the carrier was 93:7. The amount of developer in the developing unit was 150 g.

A charging roller 2 is made of epichlorohydrin rubber and has an outer diameter of 10 mm. A direct-current bias of −1.2 kV is applied to the charging roller 2 for charging the surface of the photoconductive member 1 to −600 V. Reference numeral 8 is a cleaner, 9 is a waste toner box, and 7 is a developer.

A paper is conveyed from the lower side of the transfer belt unit 17, and a paper conveying path is formed so that a paper 19 is transported by a paper feed roller (not shown) to a nip portion where the transfer belt 12 and the second transfer roller 14 are pressed against each other.

The toner is transferred from the transfer belt 12 to the paper 19 by +1000 V applied to the second transfer roller 14, and then is conveyed to a fixing portion in which the toner is fixed. The fixing portion includes a fixing roller 201, a pressure roller 202, a fixing belt 203, a heat roller 204, and an induction heater 205.

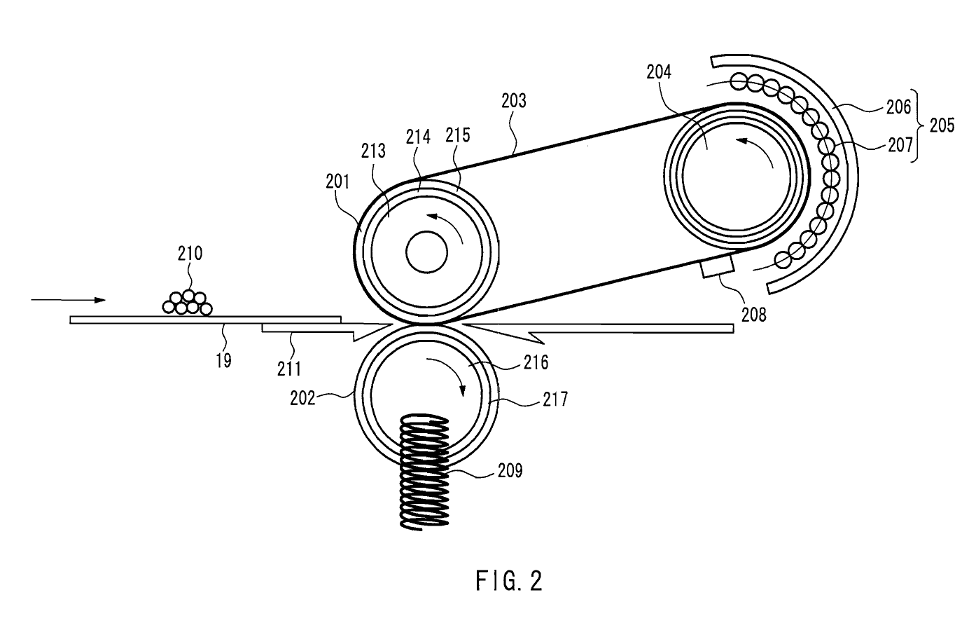

FIG. 2 shows a fixing process. A belt 203 runs between the fixing roller 201 and the heat roller 204. A predetermined load is applied between the fixing roller 201 and the pressure roller 202 so that a nip is formed between the belt 203 and the pressure roller 202. The induction heater 205 including a ferrite core 206 and a coil 207 is provided on the periphery of the heat roller 204, and a temperature sensor 208 is provided on the outer surface.

The belt 203 is formed by arranging a Ni substrate (30 μm), silicone rubber (150 μm), and PFA (tetrafluoroethylene-perfluoroalkyl vinyl ether copolymer) (30 μm) in layers.

The pressure roller 202 is pressed against the fixing roller 201 by a spring 209. A recording material 19 with the toner 210 is moved along a guide plate 211.

The fixing roller 201 axing member) includes a hollow core 213, an elastic layer 214 formed on the hollow core 213, and a silicone rubber layer 215 formed on the elastic layer 214. The hollow core 213 is made of aluminum and has a length of 250 mm, an outer diameter of 14 mm, and a thickness of 1 mm. The elastic layer 214 is made of silicone rubber with a rubber hardness (JIS-A) of 20 degrees by the JIS standard and has a thickness of 3 mm. The silicone rubber layer 215 has a thickness of 3 mm. Therefore, the outer diameter of the fixing roller 201 is about 26 mm. The fixing roller 201 is rotated at 125 mm/s with a driving force from a driving motor (not shown).

The heat roller 204 includes a hollow pipe having a thickness of 1 mm and an outer diameter of 20 mm. The surface temperature of the fixing belt is controlled to 170° C. with a thermistor.

The pressure roller 202 (pressure member) has a length of 250 mm and an outer diameter of 20 mm, and includes a hollow core 216 and an elastic layer 217 formed on the hollow core 216. The hollow core 216 is made of aluminum and has an outer diameter of 16 mm and a thickness of 1 mm. The elastic layer 217 is made of silicone rubber with a rubber hardness (JIS-A) of 55 degrees by the JIS standard and has a thickness of 2 mm. The pressure roller 202 is mounted rotatably, and a 5.0 mm width nip is formed between the pressure roller 202 and the fixing roller 201 under a one-sided load of 147N from the spring 209.

The operations will be described below. In the full color mode, all the first transfer rollers 10 of Y, M, C, and K are lifted and pressed against the respective photoconductive members 1 of the image forming units via the transfer belt 12. At this time, a direct-current bias of +800 V is applied to each of the first transfer rollers 10. An image signal is transmitted through the laser beam 3 and enters the photoconductive member 1 whose surface has been charged by the charging roller 2, thus forming an electrostatic latent image. The electrostatic latent image formed on the photoconductive member 1 is made visible by the toner on the developing roller 4 that is rotated in contact with the photoconductive member 1.

In this case, the image formation rate (125 mm/s, which is equal to the circumferential velocity of the photoconductive member) of the image forming unit 18Y is set so that the speed of the photoconductive member is 0.5 to 1.5% slower than the traveling speed of the transfer belt 12.

In the image forming process, signal light 3Y is input to the image forming unit 18Y, and an image is formed with Y toner. At the same time as the image formation, the Y toner image is transferred from the photoconductive member 1Y to the transfer belt 12 by the action of the first transfer roller 10Y, to which a direct voltage of +800 V is applied.

There is a time lag between the first transfer of the first color (Y) and the first transfer of the second color (M). Then, signal light 3M is input to the image forming unit 18M, and an image is formed with M toner. At the same time as the image formation, the M toner image is transferred from the photoconductive member 1M to the transfer belt 12 by the action of the first transfer roller 10M. In this case, the M toner is transferred onto the first color (Y) toner that has been formed on the transfer belt 12. Subsequently, the C (cyan) toner and K (black) toner images are formed in the same manner and transferred by the action of the first transfer rollers 10C and 10K. Thus, YMCK toner images are formed on the transfer belt 12. This is a so-called tandem process.

A color image is formed on the transfer belt 12 by superimposing the four color toner images in registration. After the last transfer of the K toner image, the four color toner images are transferred collectively to the paper 19 fed by a feeding cassette (not shown) at matched timing by the action of the second transfer roller 14. In this case, the follower roller 13 is grounded, and a direct voltage of +1 kV is applied to the second transfer roller 14. The toner images transferred to the paper 19 are fixed by a pair of fixing rollers 201 and 202. Then, the paper 19 is ejected through a pair of ejecting rollers (not shown) to the outside of the apparatus. The toner that is not transferred and remains on the transfer belt 12 is cleaned by the belt cleaner blade 16 to prepare for the next image formation.

Example of Visual Image Evaluation

Next, an example of evaluating visual images with a toner and a two-component developer will be described. Using an image forming apparatus, running durability tests with 100,000 sheets of A4 paper were conducted for each of various types of two-component developers that differed in a mixing ratio of the toner to the carrier, and the charge amount and the image density were measured. Moreover, background fog in a non-image portion, the uniformity of a solid image, the transfer properties (skipping in characters during transfer, reverse transfer, and transfer voids), and toner filming of the output samples were evaluated. The image density (ID) evaluation was performed by measuring a solid black portion with a reflection densitometer RD-914 (manufactured by Macbeth Division of Kollmorgen Instruments Corporation).

The charge amount was measured by a blow-off method using frictional charge with a ferrite carrier. Specifically, under the environmental conditions of 25° C. and 45% RH, 0.3 g of sample was taken to evaluate the durability, and a nitrogen gas was blown on the sample at 1.96×10⁴ Pa for 1 minute.

Table 14 shows the configurations of the toner and the carrier as the two-component developer, and the results of evaluation of the running durability test with 100,000 sheets of A4 paper for each of the two-component developers (DM1 to DM8) of the present invention and the comparative two-component developers (cm9 to cml7) that were used in this example. In Table 14, the fog level is by the measured values of a Gretag Macbeth Spectrolino/SpectroScan. If the value is 0.07 or less, it indicates a better level “A”. If the value is more than 0.07 and less than 0.1, it indicates a level “B” at which fog is slightly increased. If the value is 0.1 or more, it indicates a level “C” at which there is a problem.

The uniformity of a solid image is evaluated by taking a solid image sample on the entire surface of A4 paper. If the image density is changed only a little in part, and an image density difference is small, this level is represented by “A”. If the image density difference is observed to some extent compared to the case of “A”, this level is represented by “B”. If the image density difference is conspicuous in part, this level is represented by The transfer skipping in characters is evaluated by the state of the toner present on the periphery of a line when a series of characters “ [symbol] , [symbol] , [symbol] ” is printed. If the amount of toner present on the periphery of a line is very small, this level is represented by “A”. If there is a small amount of toner on the periphery of a line, this level is represented by “B”. If there is a large amount of toner on the periphery of a line, this level is represented by “C”.

In the case of printing of an image sample with two or more colors, when the second color toner is transferred from the photoconductive member to the transfer belt after the transfer of the first color toner from the photoconductive member to the transfer belt, a part of the first color toner can adhere to the photoconductive member of the second color toner. This phenomenon is called reverse transfer. The reverse transfer is evaluated by visually observing the amount of toner that is removed from the photoconductive member of the second color toner using a cleaning blade and then collected in the waste toner box. If the first and second color toners are almost never mixed, this level is represented by “A”. If the first and second color toners are mixed to some extent, this level is represented by “B”. If the mixture of the first and second color toners can be seen clearly, this level is represented by “C”.

The transfer void is evaluated by printing a cross pattern “+” and observing the state of the toner at the point of intersection. If the toner is present at the intersection point, this level is represented by “A”. If there are some voids at the intersection point, in which the toner has not been transferred, this level is represented by “B”. If no toner is present at the intersection point, this level is represented by “C”.

TABLE 14

| | | | Image density | | | | | | |
|---|---|---|---|---|---|---|---|---|---|
| | | Filming on | (ID) | | | Uniformity | Transfer | | |
| | | photoconductive | initial/after | | | of solid | skipping in | Reverse | Transfer |
| Developer | Toner | member | test | | Fog | image | characters | transfer | void |
| DM1 | TM1 | Not occur | 1.45 | 1.44 | A | A | A | A | A |
| DM2 | TM2 | Not occur | 1.48 | 1.45 | A | A | A | A | A |
| DM3 | TM3 | Not occur | 1.50 | 1.52 | A | A | A | A | A |
| DM4 | TM4 | Not occur | 1.35 | 1.32 | A | A | A | A | A |
| DM5 | TM5 | Not occur | 1.46 | 1.42 | A | A | A | A | A |
| DM6 | TM6 | Not occur | 1.44 | 1.41 | A | A | A | A | A |
| DM7 | TM7 | Not occur | 1.42 | 1.41 | A | A | A | A | A |
| DM8 | TM8 | Not occur | 1.49 | 1.42 | A | A | A | A | A |
| cm9 | tm9 | Occur | 1.36 | 1.32 | B | C | B | B | B |
| cm10 | tm10 | Occur | 1.47 | 1.42 | B | C | B | B | B |
| cm11 | tm11 | Occur | 1.39 | 1.33 | B | C | B | B | B |
| cm12 | tm12 | Occur | 1.44 | 1.40 | B | C | B | B | B |
| cm13 | tm13 | Occur | 1.21 | 1.28 | C | C | C | C | C |
| cm14 | tm14 | Occur | 1.31 | 1.20 | C | C | C | C | C |
| cm15 | tm15 | Occur | 1.25 | 1.12 | C | C | C | C | C |
| cm16 | tm16 | Occur | 1.29 | 1.21 | C | C | C | C | C |
| cm17 | tm17 | Occur | 1.41 | 1.46 | C | C | B | B | B |

For all the two-component developers DM1 to DM8 using the toner of the present invention, toner filming on the photoconductive member was not a problem for practical use after the running durability test with 100,000 sheets of A4 paper. The toner filming on the transfer belt also was not a problem for practical use. Moreover, a cleaning failure of the transfer belt did not occur. In the case of a full color image formed by superimposing three colors, a paper was not wound around the fixing belt.

With respect to the image density before and after the running durability test, high-resolution images having a density of 1.3 or more were obtained by each of the two-component developers DM1 to DM8 using the toner of the present invention. Even after the durability test with 100,000 sheets of A4 paper, the flowability of the two-component developers was stable, the image density was 1.3 or more and not changed much, and stable characteristics were maintained.

With respect to fog in the non-image portion and the solid image uniformity, the two-component developers DM11 to DM22 of the present invention had a high image density, caused neither background fog in the non-image portion nor toner scattering, and achieved high resolution. The solid images in development also had good uniformity.

Moreover, no streak occurred in the images over continuous use. There was almost no spent of the toner components on the carrier. Both a change in carrier resistance and a decrease in charge amount were suppressed. When the solid images were developed continuously, and then the toner was supplied quickly, the charge build-up property was good. The fog was not increased under high humidity conditions. Moreover, high saturation charge was maintained over a long period of use. The charge amount hardly varied at low temperature and low humidity.

With respect to the transfer properties (skipping in characters during transfer, reverse transfer, and transfer voids), for all the two-component developers DM1 to DM8 of the present invention, transfer voids or the like were not a problem for practical use, and no transfer defect occurred in the full color image consisting of three superimposed colors. The transfer efficiency was about 95%.

Even if the mixing ratio of the toner to the carrier was changed by 5 to 20 wt %, the two-component developers DM1 to DM8 of the present invention changed little in image density and image quality such as background fog. Thus, the toner concentration was controlled in a wide range.

On the other hand, toner filming on the photoconductive member occurred in the comparative two-component developers cm9 to cm17 during the running durability test. With respect to the image density before and after the running durability test, the image density was low or reduced due to an increase in charge amount over a long period of use, and fog in the non-image portion was increased. When the solid images were developed continuously, and then the toner was supplied quickly, the charge was decreased, and fog was increased. This phenomenon became worse, particularly under high humidity conditions. Moreover, when the mixing ratio of the toner to the carrier was in the range of 6 to 8 wt %, the image density and the image quality such as background fog were changed little, even if the toner concentration was changed. However, the image density was reduced as the mixing ratio was smaller than this range, while the background fog was increased as the mixing ratio was larger than this range.

Next, Table 15 shows the results of the evaluation of the fixability, offset resistance, high-temperature storage stability, and winding of paper around the fixing belt of a full color image. In Table 15, “A” of the storage stability test indicates that the result is good, and no thermal aggregation occurs after being left standing at high temperatures, thus maintaining the powdered state. Although “B” is slightly inferior to “A”, it indicates that the thermal aggregation can be broken by applying a small load of 30 g/cm² or more. On the other hand, “C” indicates that there is a problem, and agglomeration occurs after being left standing at high temperatures, so that the lump cannot be broken unless a load of 300 g/cm² or more is applied.

In this case, a solid image was fixed in an amount of 1.2 mg/cm² at a process speed of 125 mm/s by using a fixing device provided with an oilless belt, and the OHP film transmittance (fixing temperature: 160° C.), the minimum fixing temperature, and the temperature at which high-temperature offset occurs were measured. As to the storage stability, the state of the toner was evaluated after being left standing at 55° C. for 24 hours.

The OHP film transmittance was measured with 700 nm light by using a spectrophotometer (U-3200 manufactured by Hitachi, Ltd.).

TABLE 15

| | OHP | Minimum fixing | High-temperature | Storage | |
|---|---|---|---|---|---|
| | transmittance | temperature | offset generation | stability | Winding around |
| Toner | (%) | (° C.) | temperature (° C.) | test | fixing belt |
| TM1 | 88.9 | 125 | 210 | A | Not occur |
| TM2 | 87.9 | 130 | 210 | A | Not occur |
| TM3 | 82.7 | 135 | 220 | A | Not occur |
| TM4 | 83.2 | 135 | 220 | A | Not occur |
| TM5 | 87.4 | 130 | 220 | A | Not occur |
| TM6 | 86.7 | 130 | 220 | A | Not occur |
| TM7 | 86.9 | 130 | 220 | A | Not occur |
| TM8 | 83.5 | 135 | 220 | A | Not occur |
| tm9 | 86.8 | 130 | 160 | C | Occur |
| tm10 | 84.6 | 140 | 160 | C | Occur |
| tm11 | 69.3 | 180 | 220 | B | Not occur |
| tm12 | 70.5 | 180 | 210 | B | Not occur |
| tm13 | 79 | 150 | 180 | B | Not occur |
| tm14 | 70.8 | 160 | 180 | B | Not occur |
| tm15 | 74.8 | 160 | 200 | B | Not occur |
| tm16 | 73.4 | 140 | 160 | C | Occur |
| tm17 | 75.3 | 150 | 200 | B | Occur |

All the toners TM11 to TM8 of the present invention exhibited good fixability, since the OHP film transmittance was 80% or more. With respect to the offset resistance, the offset resistance temperature range was increased by using the fixing roller without oil. Moreover, the fixable temperature range (from the minimum fixing temperature to the temperature at which high-temperature offset occurs) was wide. No offset occurred in the test of the formation of full color solid images on 200,000 sheets of plain paper. Even if a silicone or fluorine-based fixing belt was used without oil, the surface of the belt did not wear. With respect to the high temperature storage stability, agglomeration hardly was observed in the storage stability test of 50° C. for 24 hours. With respect to the winding of paper around the fixing belt, no jam of an OHP film occurred in the nip portion of the fixing device.

For the toners tm9, tm10, and tm16, the offset resistance was low, and a margin of the fixable range was narrow. For the toners tm11, tm12, tm14, and tm15, the low-temperature fixability was low, and a margin of the fixable range was narrow. For the toners tm9 to tm17, the storage stability was degraded, which was attributed to the effect of suspended wax or resin particles remaining in the toner.

### INDUSTRIAL APPLICABILITY

The toner of the present invention is used suitably for image forming apparatuses such as a printer and a facsimile machine. Moreover, the present invention is useful not only for an electrophotographic system including a photoconductive member, but also for a printing system in which the toner adheres directly on paper or the toner including a conductive material is applied on a substrate as a wiring pattern.

1. A toner comprising core particles formed by mixing and aggregating in an aqueous medium at least a resin particle dispersion in which resin particles are dispersed, a colorant particle dispersion in which colorant particles are dispersed, and a wax particle dispersion in which particles of wax are dispersed,
wherein the wax comprises at least a first wax and a second wax,
wherein an endothermic peak temperature (referred to as a melting point Tmw1 (° C.)) of the first wax by a differential scanning calorimetry (DSC) method is 50° C. to 90° C., and an endothermic peak temperature (referred to as a melting point Tmw2 (° C.)) of the second wax by the DSC method is 5° C. to 50° C. higher than Tmw1 of the first wax,
wherein Jmw1/Jw1 is 0.5 or less and Jmw2/Jw2 is 0.5 to 1.2, where Jw1 (J/g) represents an endotherm of the first wax by the DSC method, Jw2 (J/g) represents an endotherm of the second wax by the DSC method, Jmw1 (J/g) represents a melting endotherm of the first wax by a modulated differential scanning calorimetry (MDSC) method, and Jmw2 (J/g) represents a melting endotherm of the second wax by the MDSC method, and
wherein the first wax and the second wax are mixed so as to provide a dispersion beforehand, the dispersion is then mixed with the resin particle dispersion and the colorant particle dispersion, and the particles are aggregated to form the core particles.

2. The toner according to claim 1, wherein the endothermic peak temperature (referred to as a melting point Tmw1 (° C.)) of the first wax by the DSC method is 50° C. to 90° C., and the endothermic peak temperature (referred to as a melting point Tmw2 (° C.)) of the second wax by the DSC method is 80° C. to 120° C.

3. The toner according to claim 1, wherein the first wax comprises an ester wax composed of at least one of a higher alcohol having a carbon number of 16 to 24 and a higher fatty acid having a carbon number of 16 to 24, and
the second wax comprises an aliphatic hydrocarbon wax.

4. The toner according to claim 1, wherein the first wax comprises a wax having an iodine value of not more than 25 and a saponification value of 30 to 300, and the second wax comprises an aliphatic hydrocarbon wax.

5. The toner according to claim 1, wherein a mixing ratio of the second wax to the first wax FT2/ES1 is 0.2 to 10, where ES1 represents a weight ratio of the first wax and FT2 represents a weight ratio of the second wax.

6. The toner according to claim 1, wherein a gel permeation chromatography (GPC) measurement shows that a tetrahydrofuran (THF) soluble portion of the resin particles has a number-average molecular weight (Mn) of 3000 to 15000, a weight-average molecular weight (Mw) of 10000 to 60000, and a ratio (Mw/Mn) of the weight-average molecular weight (Mw) to the number-average molecular weight (Mn) of 1.5 to 6.

7. The toner according to claim 1, wherein a second resin particle dispersion in which second resin particles are dispersed is added to and mixed with the core particles, and then the mixture is heated so that the second resin particles are fused with the core particles.

8. The toner according to claim 7, wherein a gel permeation chromatography (GPC) measurement shows that a tetrahydrofuran (THF) soluble portion of the second resin particles has a number-average molecular weight (Mn) of 9000 to 30000, a weight-average molecular weight (Mw) of 50000 to 500000, and a ratio (Mw/Mn) of the weight-average molecular weight (Mw) to the number-average molecular weight (Mn) of 2 to 10.

9. The toner according to claim 1, wherein a particle size of the wax particles in a mixed dispersion of the first wax and the second wax ranges from 20 nm to 200 nm for 16% diameter (PR16), 40 nm to 300 nm for 50% diameter (PR50), and is not more than 400 nm for 84% diameter (PR84), and PR84/PR16 is 1.2 to 2.0 in a cumulative volume particle size distribution cumulated from a smaller particle diameter side, and
wherein a ratio of particles having a diameter not greater than 200 nm is 65 vol % or more, and a ratio of particles having a diameter greater than 500 nm is 10 vol % or less.

10. A method for producing a toner comprising:
forming core particles by mixing and aggregating in an aqueous medium at least a resin particle dispersion in which resin particles are dispersed, a colorant particle dispersion in which colorant particles are dispersed, and a wax particle dispersion in which particles of wax are dispersed,
wherein the wax comprises at least a first wax and a second wax,
wherein an endothermic peak temperature (referred to as a melting point Tmw1 (° C.)) of the first wax by a differential scanning calorimetry (DSC) method is 50° C. to 90° C., and a ratio (Jmw1/Jw1) of a melting endotherm Jmw1 (J/g) of the first wax by a modulated differential scanning calorimetry (MDSC) method to an endotherm Jw1 (J/g) of the first wax by the DSC method is 0.5 or less,
wherein an endothermic peak temperature (referred to as a melting point Tmw2 (° C.)) of the second wax by the DSC method is 5° C. to 50° C. higher than Tmw1 of the first wax, and a ratio (Jmw2/Jw2) of a melting endotherm Jmw2 (J/g) of the second wax by the MDSC method to an endotherm Jw2 (J/g) of the second wax by the DSC method is 0.5 to 1.2, and
wherein the wax particle dispersion, the resin particle dispersion, and the colorant particle dispersion are mixed and aggregated in the aqueous medium.

11. The method according to claim 10, wherein the resin particle dispersion, the colorant particle dispersion, and the wax particle dispersion are mixed to form a mixed dispersion, and an aggregating agent is added to the mixed dispersion after heat treatment, thereby forming the core particles.

12. The method according to claim 10, wherein the aggregating agent is added after a water temperature of the mixed dispersion containing the resin particle dispersion, the colorant particle dispersion, and the wax particle dispersion reaches at least the melting point of the first wax.

13. The method according to claim 10, wherein a surface-active agent used for the resin particle dispersion is a mixture of a nonionic surface-active agent and an ionic surface-active agent, and a main component of a surface-active agent used for the colorant particle dispersion and the wax particle dispersion is only a nonionic surface-active agent.

14. The method according to claim 10, wherein the endothermic peak temperature (referred to as a melting point Tmw1 (° C.)) of the first wax by the DSC method is 50° C. to 90° C., and the endothermic peak temperature (referred to as a melting point Tmw2 (° C.)) of the second wax by the DSC method is 80° C. to 120° C.

15. The method according claim 10, wherein the first wax comprises an ester wax composed of at least one of a higher alcohol having a carbon number of 16 to 24 and a higher fatty acid having a carbon number of 16 to 24, and the second wax comprises an aliphatic hydrocarbon wax.

16. The method according to claim 10, wherein the first wax comprises a wax having an iodine value of not more than 25 and a saponification value of 30 to 300, and the second wax comprises an aliphatic hydrocarbon wax.

17. The method according to claim 10, wherein the wax particle dispersion is produced by mixing, emulsifying, and dispersing the first wax and the second wax.

18. The method according to claim 10, wherein the wax particle dispersion is produced by mixing, emulsifying, and dispersing the first wax and the second wax with a surface-active agent that includes a nonionic surface-active agent as a main component.

19. The method according to claim 10, wherein pH of the wax particle dispersion containing the mixed dispersion of the first wax and the second wax, the resin particle dispersion, and the colorant particle dispersion is adjusted in the range of 9.5 to 12.2.

20. The method according to claim 10, wherein a particle size of the wax particles in the mixed dispersion of the first wax and the second wax ranges from 20 nm to 200 nm for 16% diameter (PR16), 40 nm to 300 nm for 50% diameter (PR50), and is not more than 400 nm for 84% diameter (PR84), and PR84/PR16 is 1.2 to 2.0 in a cumulative volume particle size distribution cumulated from a smaller particle diameter side, and
wherein a ratio of particles having a diameter not greater than 200 nm is 65 vol % or more, and a ratio of particles having a diameter greater than 500 nm is 10 vol % or less.
